(19) United States
(12) Patent Application Publication
(10) Pub. No.: US 2008/0278845 A1
(43) Pub. Date: Nov. 13, 2008

(54) Magnetic recording/reproducing apparatus

(75) Inventors: Hirofumi Asai, Atsugi-shi (JP); Takuro Negi, Atsugi-shi (JP); Ikuichiro Nawa, Atsugi-shi (JP); Morikazu Okada, Atsugi-shi (JP); Ryoichi Annen, Atsugi-shi (JP)

Correspondence Address: IPUSA, P.L.L.C, 1054 31ST STREET, N.W., Suite 400, Washington, DC, 20007, US

(73) Assignee: MITSUMI ELECTRIC CO., LTD.

(21) Appl. No.: 12/149,121

(22) Filed: Apr. 28, 2008

(30) Foreign Application Priority Data
May 11, 2007 (JP) 2007-126809

(51) Int. Cl. G11B 5/027

(52) U.S. Cl. 360/83

(57) ABSTRACT

A magnetic recording/reproducing apparatus includes a rotating drum unit for recording data to a magnetic tape of a tape cassette or reproducing data recorded to the magnetic tape, a tape guiding member for pulling the magnetic tape out from the tape cassette for forming a tape path, a tape loading member for winding the magnetic tape around the rotating drum unit. The magnetic recording/reproducing apparatus further includes a tape guide moving mechanism having a driving force transmitting member configured to transmit a driving force, a supporting base configured to support the tape guiding member, a first arm member having one end rotatably connected to the supporting base via a first connecting pin, and a second arm member configured to connect the first arm part and the driving force transmitting part and configured to rotatably connect to the other end of the first arm member via a second connecting pin.

### BACKGROUND OF THE INVENTION

1. Field of the Invention

The present invention generally relates to a magnetic recording/reproducing apparatus, and more particularly to a magnetic recording/reproduction apparatus for conducting magnetic recording or magnetic reproduction by scanning a tape pulled out from a tape cassette and wound around a rotating drum upon loading the tape cassette to the magnetic recording/reproduction apparatus.

2. Description of the Related Art

A magnetic recording/reproduction apparatus having a rotating drum and a tape cassette loading mechanism is used as, for example, an external storage apparatus (e.g., streamer device). This type of magnetic recording/reproduction apparatus is configured to allow magnetic tape cassettes having different tape widths to be selectively mounted thereto. Furthermore, the magnetic recording/reproduction apparatus is configured to operate a tape loading mechanism based on detection signals output from a detection switch for detecting different types of tape cassettes (See, for example, Japanese Laid-Open Patent Application No. 2004-288244).

Furthermore, in a tape loading mechanism of a magnetic recording/reproduction apparatus according to a related art example, a magnetic tape is pulled out from a tape cassette by inserting a tape guide roller to the inner side of the magnetic tape span across a winding reel and a supplying reel of the tape cassette and rotating a tape guide roller supporting arm provided on one end of the tape guide roller. The magnetic tape pulled out from the tape cassette forms a tape path being wound around an outer periphery of a rotating drum over a predetermined angle range by operations of a tape loading member.

The magnetic tape is applied with a tension (back tension) by the tape guide roller of the supplying side of the rotating drum, pressed against a capstan on the winding side of the rotating drum by a pinch roller, and applied with a driving force in a winding direction. Then, the magnetic tape travels in the winding direction along with the rotation of the rotating drum. Thereby, magnetic recording or magnetic reproduction according to a helical scanning method is performed on the magnetic tape.

In the magnetic recording/reproduction apparatus according to the related art example, when the tape cassette is loaded and a sliding operation of a slide lever of a tape loading mechanism is initiated, a driving pin provided in an upright manner on the slide lever rotates an arm member connected to a supporting base supporting the tape guide member as a toggle, and the supporting base contacts a stopper provided on a chassis, to thereby maintain a tape loading position (tape path forming position).

In the magnetic recording/reproduction apparatus according to the related art example, in order to maintain the contacting state between the supporting base of the tape guide member and the stopper, there is a configuration the stopper and the supporting base are pressed together by applying a spring force to the supporting base. For example, in a configuration where a spring member is provided in the path for transmitting a sliding movement of the slide lever (motion transmitting path), the spring member applies a spring force to the supporting base as the slide lever is moved from a state where the supporting base is in contact with the stopper. However, with such a configuration, due to various sizes of the motion transmitting components provided in the motion transmitting path or backlash of connecting pins that connect the motion transmitting components, motion tends to be transmitted insufficiently. Therefore, such a configuration requires a spring member capable of generating a large position maintaining force (pressing force) for maintaining the position of the supporting base.

For example, in a case where the position maintaining force for maintaining the position of the supporting base is 100 gram-force (gf), the spring member requires a torque of approximately 120 gf·cm to 130 gf·cm. However, because a spring member having a strong spring force may adversely affect the operations of the motion transmitting components, it is necessary to use a spring member having a small amount of spring force (e.g., reduced to approximately 60% to 70%). Nevertheless, in such a case where a spring member with a reduced spring force is used, a sufficient position maintaining force cannot be attained for the tape guide member. This may result in an unstable tape path where the tape guide member is easily wobbled by changes in the tension of the tape wound around the rotating drum.

### SUMMARY OF THE INVENTION

The present invention provides a magnetic recording/reproducing apparatus that substantially eliminates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a magnetic recording/reproducing apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a magnetic recording/reproducing apparatus including a rotating drum unit for recording data to a magnetic tape of a tape cassette or reproducing data recorded to the magnetic tape, a tape guiding member for pulling the magnetic tape out from the tape cassette for forming a tape path, a tape loading member for winding the magnetic tape around the rotating drum unit, having a tape guide moving mechanism including a driving force transmitting member configured to transmit a driving force, a supporting base configured to support the tape guiding member, a first arm member having one end rotatably connected to the supporting base via a first connecting pin, and a second arm member configured to connect the first arm part and the driving force transmitting part and rotatably connected to the other end of the first arm member via a second connecting pin.

Other objects and further features of the present invention will be apparent from the following detailed description when read in conjunction with the accompanying drawings.

### BRIEF DESCRIPTION OF THE DRAWINGS

FIG. 1 is a perspective view showing a existing-type tape cassette, a new-type tape cassette, and a streamer device according to an embodiment of the present invention;

FIG. 2 is a plan view showing the streamer device of FIG. 1 according to an embodiment of the present invention;

FIG. 3 is a diagram for explaining tape loading operations that are performed when a existing-type tape cassette is loaded into a streamer device according to an embodiment of the present invention;

FIG. 4 is a diagram for explaining tape loading operations that are performed when a new-type tape cassette is loaded into a streamer device according to an embodiment of the present invention;

FIG. 5 is a diagram showing the state of a streamer device after tape loading operations for a existing-type tape cassette are completed according to an embodiment of the present invention;

FIG. 6 is a diagram showing the state of a streamer device after tape loading operations for a new-type tape cassette are completed according to an embodiment of the present invention;

FIGS. 7A˜7C are diagrams showing a 4 mm-width magnetic tape and an 8 mm-width magnetic tape that are wound onto a rotating drum unit, and track patterns that are formed on the magnetic tapes according to an embodiment of the present invention;

FIGS. 8A and 8B are diagrams illustrating the state of a streamer device when an existing-type tape cassette is loaded according to an embodiment of the present invention;

FIG. 9 is a diagram illustrating the state of a streamer device after a first operations step of FIG. 3 is completed according to an embodiment of the present invention;

FIG. 10 is a diagram illustrating the state of a streamer device after a second operations step of FIG. 3 is completed according to an embodiment of the present invention;

FIG. 11 is a diagram illustrating the state of a streamer device after a third operations step of FIG. 3 is completed according to an embodiment of the present invention;

FIGS. 12A and 12B are diagrams illustrating the state of a streamer device when a new-type tape cassette is loaded according to an embodiment of the present invention;

FIGS. 13A and 13B are diagrams illustrating the state of a streamer device when a first operations step of FIG. 4 is completed according to an embodiment of the present invention;

FIG. 14 is a diagram illustrating the state of a streamer device after a second operations step of FIG. 4 is completed according to an embodiment of the present invention;

FIG. 15 is a diagram illustrating the state of a streamer device when a third operations step of FIG. 4 is being performed according to an embodiment of the present invention;

FIG. 16 is another diagram illustrating the state of a streamer device when the third operations step of FIG. 4 is being performed according to an embodiment of the present invention;

FIG. 17 is a diagram illustrating the state of a streamer device after the third operations step of FIG. 4 is completed according to an embodiment of the present invention;

FIG. 18 is a diagram illustrating the state of a streamer device after a fourth operations step of FIG. 4 is completed according to an embodiment of the present invention;

FIG. 19 is a perspective view of an underside of a first motion transmitting mechanism according to an embodiment of the present invention;

FIG. 20 is a perspective view showing the initial state of a pole moving mechanism according to an embodiment of the present invention;

FIG. 21 is a perspective view showing the state of a pole moving mechanism when corresponding poles are moved according to an embodiment of the present invention;

FIG. 22 is a perspective view showing the initial state of a pole raising/lowering mechanism when corresponding poles are lowered according to an embodiment of the present invention;

FIG. 23 is a perspective view showing the state of a pole raising/lowering mechanism when corresponding poles are raised according to an embodiment of the present invention;

FIG. 24 is a perspective view showing a state before a tape loading operation of a tape guide moving mechanism according to an embodiment of the present invention;

FIG. 25 is a perspective view showing a state after a tape loading operation of a tape guide moving mechanism according to an embodiment of the present invention;

FIG. 26 is a perspective view of an underside of a tape guide moving mechanism according to an embodiment of the present invention;

FIG. 27 is a side view of a tape guide moving mechanism and a pole raising/lowering mechanism according to an embodiment of the present invention;

FIG. 28 is a perspective view of an underside of a tape guide moving mechanism according to an embodiment of the present invention;

FIG. 29 is a perspective view of a top side of a tape guide moving mechanism according to an embodiment of the present invention;

FIG. 30 is a perspective view of an underside of a tape guide moving mechanism when a corresponding pole is moved to a tape path forming position according to an embodiment of the present invention;

FIG. 31 is a perspective view of a top side of a tape guide moving mechanism when a corresponding pole is moved to a tape path forming position according to an embodiment of the present invention;

FIG. 32 is a top plan view of a tape guide moving mechanism when a corresponding pole is moved to a tape path forming position according to an embodiment of the present invention;

FIG. 33 is a perspective view of a top side of an oscillating member according to an embodiment of the present invention;

FIG. 34A is a plan view of an oscillating member according to an embodiment of the present invention;

FIG. 34B is a side view of an oscillating member according to an embodiment of the present invention;

FIG. 35 is a perspective view showing an attached state of an oscillating member according to an embodiment of the present invention;

FIG. 36 is a plan view for explaining a first operations state of an oscillating member according to an embodiment of the present invention;

FIG. 37 is a plan view for explaining a second operations state of an oscillating member according to an embodiment of the present invention;

FIG. 38 is a plan view for explaining a third operations state of an oscillating member according to an embodiment of the present invention;

FIG. 39 is a perspective view showing a pole raising/lowering mechanism according to an embodiment of the present invention;

FIG. 40 is a perspective view showing an upper plate 289 according to an embodiment of the present invention;

FIG. 41 is a perspective view showing a raising/lowering member according to an embodiment of the present invention;

FIG. 42 is a perspective view showing a lower plate according to an embodiment of the present invention;

FIG. 43 is a rear view showing the state where a supporting base is raised according to an embodiment of the present invention; and

FIG. 44 is a side view showing the state where a supporting base is raised according to an embodiment of the present invention.

### DESCRIPTION OF THE PREFERRED EMBODIMENTS

In the following, embodiments of the present invention will be described with reference to the accompanying drawings.

### First Embodiment

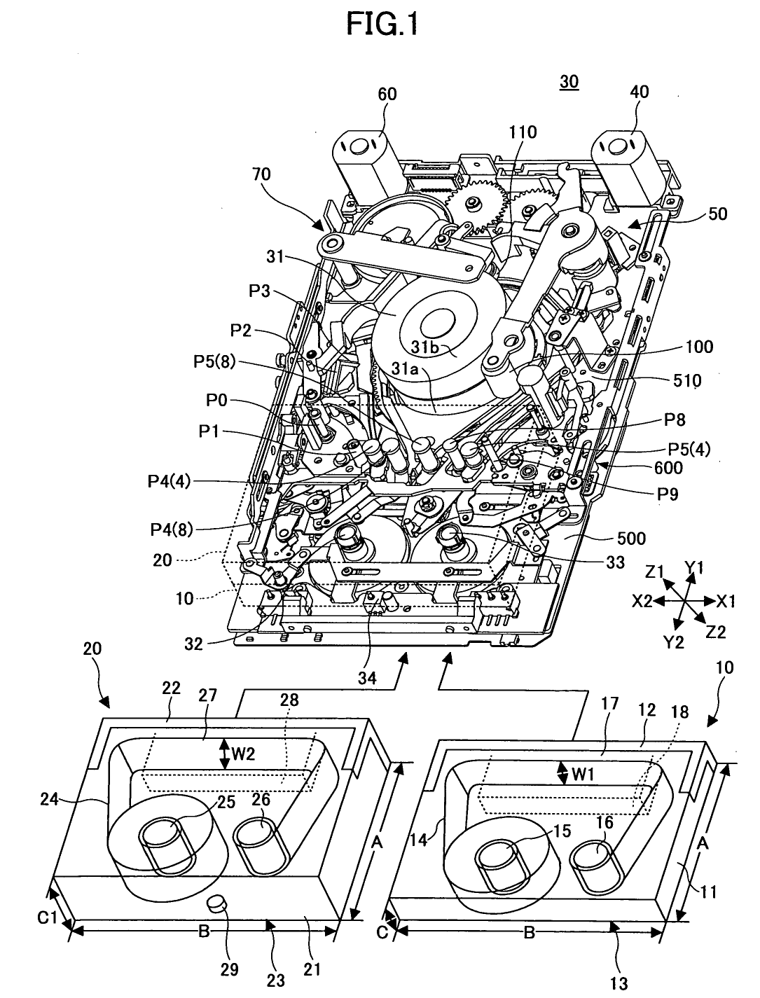

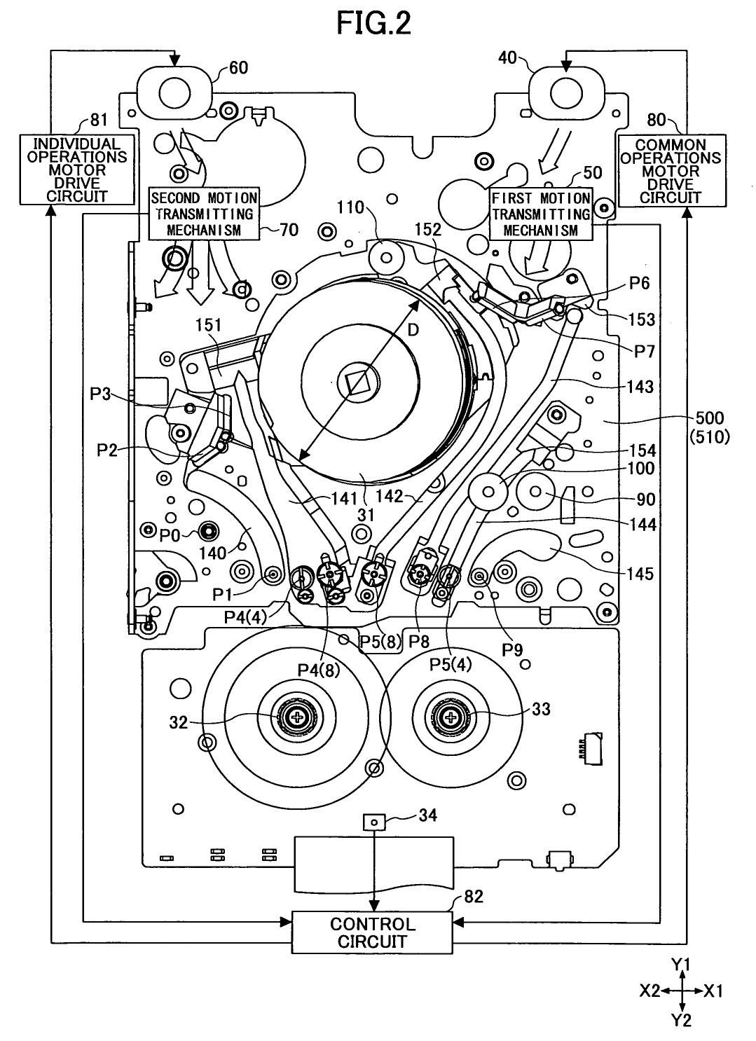

FIG. 1 is a perspective view showing a streamer device 30 applying a magnetic recording/reproducing apparatus according to a first embodiment of the present invention. FIG. 2 is a plan view showing the stream device 30 according to an embodiment of the present invention. It is noted that, in FIG. 2, a main chassis 500 and a sub-chassis 510 are illustrated on the same plane for the sake of convenience. In the following, overall functions and operations of the streamer device 30 are described.

### 1. [Outline of Streamer Device 30]

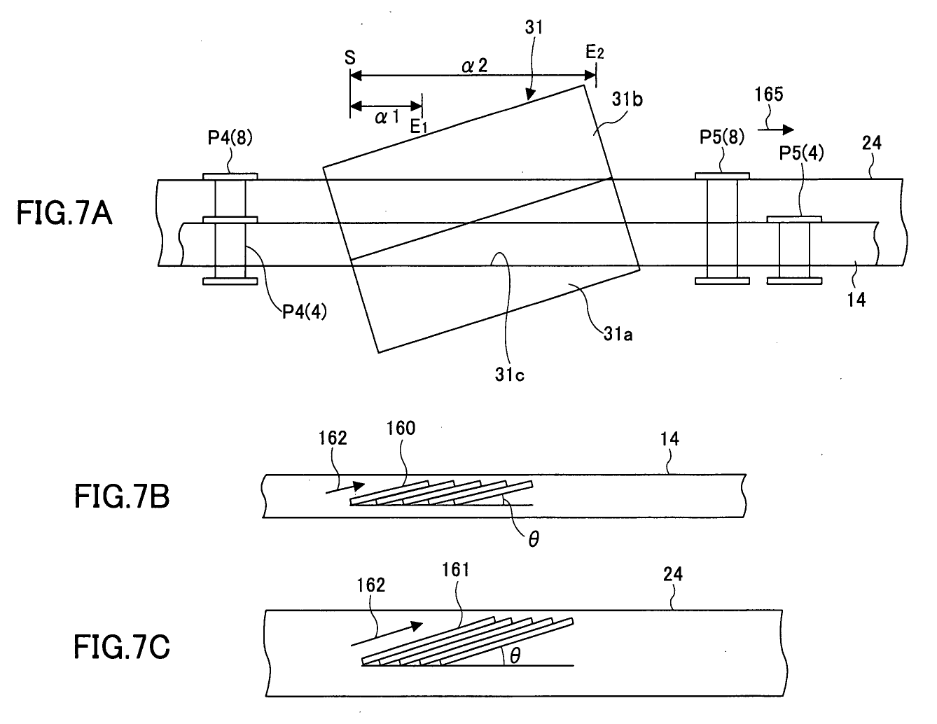

FIGS. 1 and 2 illustrate the state of the streamer device 30 before a tape cassette is loaded thereto. It is noted that in these drawings, directions X1-X2 represent width directions, directions Y1-Y2 represent length directions, and directions Z1-Z2 represent height directions. The streamer device 30 is capable of selectively loading a tape cassette (existing-type tape cassette) 10 having a magnetic tape 14 with a width of 4 mm or a tape cassette (new-type tape cassette) 20 having a magnetic tape 24 with a width of 8 mm. A rotating drum unit 31 of the streamer device 30 according to the present embodiment is configured so that the winding angle for winding the magnetic tape with a width of 8 mm onto the rotating drum unit 31 is arranged to be greater than the winding angle for the magnetic tape with a width of 4 mm. As is shown in FIG. 7A, the rotating drum 31 includes a lower stationary drum 31a and an upper rotating drum 31b. A rotating head is fixed to the bottom surface of the rotating drum 31b, and a tape guide 31c for guiding the bottom edge of the magnetic tape 14/24 onto the stationary drum 31a is provided.

The streamer device 30 has various components mounted on its main chassis 500 and sub-chassis 510. For example, the streamer device 30 includes a cassette loading mechanism (not shown), the rotating drum unit 31 having plural rotating heads, a common operations motor 40, a first motion transmitting mechanism 50 that transmits the rotation of the common operations motor 40, an individual operations motor 60, a second motion transmitting mechanism 70 that transmits the rotation of the individual operations motor 60 in a clockwise direction to a first part and transmits the rotation of the individual operations motor 60 in a counter-clockwise direction to a second part, a common operations motor drive circuit 80, an individual operations motor drive circuit 81, and a control circuit 82 including a microcomputer, for example. The cassette loading mechanism includes a housing that is adapted for a new-type tape cassette 20, and is configured to be capable of selectively loading an existing-type tape cassette 10 and the new-type tape cassette 20.

The main chassis 500 is a base for supporting main parts such as the rotating drum unit 31, the common operations motor 40, the individual operations motor 60, and the cassette loading mechanism. The sub-chassis 510 is supported above the main chassis 500. The sub-chassis 510 is provided with, for example, a tape loading mechanism and a tape guide moving mechanism 600.

The common operations motor 40 is driven when operating a common tape loading mechanism directed to both the magnetic tape 14 with a width of 4 mm and the magnetic tape 24 with a width of 8 mm. The rotation of the common operations motor 40 is transmitted to the common tape loading mechanism via the first motion transmitting mechanism 50 so that the common tape loading mechanism may be operated.

The individual operations motor 60 is rotated in a clockwise direction upon operating a 4 mm-width magnetic tape loading mechanism directed to the magnetic tape 14 with a width of 4 mm. The individual operations motor 60 is rotated in a counter-clockwise direction upon operating an 8 mm-width magnetic tape loading mechanism directed to the magnetic tape 24 with a width of 8 mm. The rotation of the individual operations motor 60 in the clockwise direction is transmitted to the 4 mm-width magnetic tape loading mechanism via the second motion transmitting mechanism 50 so that the 4 mm-width magnetic tape loading mechanism may be operated. The rotation of the individual operations motor 60 in the counter-clockwise direction is transmitted to the 8 mm-width magnetic tape loading mechanism via the second motion transmitting mechanism 50 so that the 8 mm-width magnetic tape loading mechanism may be operated.

The streamer device 30 also includes loading poles P0˜P9 for guiding the traveling of the magnetic tape 14/24 (simply referred to as ‘pole’ hereinafter), a capstan 90, a pinch roller 100, and a head cleaner 110. The poles P0, P1, P2, P3, and P9 are commonly used by both the magnetic tapes 14/24 with widths of 4 mm and 8 mm. The poles P4(4) and P5(4) are dedicated to the magnetic tape 14 with a width of 4 mm, and poles P4(8), P5(8), P6, P7, and P8 are dedicated to the magnetic tape 24 with a width of 8 mm. It is noted that the numbers 4 and 8 in parentheses indicate the magnetic tape widths in millimeter units. The poles P0, P1, P2, P3 operate the common tape loading mechanism, the poles P4(4) and P5(4) operate the 4 mm-width magnetic tape loading mechanism, and the poles P4(8), P5(8), P6, P7, and P8 operate the 8 mm-width magnetic tape loading mechanism.

Also, it is noted that the poles P0, P2, P3, P6, and P7 correspond to stationary poles, and poles P1, P4(4), P4(8), P5(8), P8, P5(4), and P9 correspond to moving poles. The pole P0 is positioned at the X2 side of a tape cassette loading portion. The poles P2 and P3 are arranged such that their upper ends tilt toward each other to form a pair. The poles P2 and P3 are positioned at the entrance side of the rotating drum unit 31 with respect to the scanning direction of the magnetic tape, and are configured to provide a twist to the magnetic tape. The poles P5 and P6 are arranged such that their upper ends tilt away from each other to form a pair. The poles P5 and P6 are positioned at the exit side of the rotating drum unit 31 with respect to the scanning direction of the magnetic tape, and are configured to provide a twist to the magnetic tape. The capstan 90 is positioned at the X1 side of the cassette loading portion. The pinch roller 100 is normally positioned at a high position, and is positioned close to the capstan 90. The moving poles P1, P4(4), P4(8), P5(8), P8, P5(4), and P9 are arranged within the tape cassette loading portion in this order from the X2 side to the X1 side.

Of the moving poles P1, P4(4), P4(8), P5(8), P8, P5(4), and P9, the poles P1, P4(8), P5(8), P8, and P9 are arranged to be longer than the poles P4(4) and P5(4). The longer poles P1, P4(8), P5(8), P8, and P9 are lowered in the Z2 direction with respect to the shorter poles P4(4) and P5(4) so that the heights of the top ends of the moving poles P1, P4(4), P4(8), P5(8), P8, P5(4), and P9 are arranged to be the same. As is described in detail below, according to this arrangement, the bottom edge of the existing-type tape cassette 10 may be loaded at the same height as that of the new-type tape cassette 20 without interfering with the longer poles.

### 2. [Structures of Tape Cassettes 10 and 20]

In the following, the structures of the tape cassettes 10 and 20 are described with reference to FIG. 1.

The existing-type tape cassette 10 includes a cassette body 13 that is made of a box structure 11, a front lid 12, and a bottom slide board (not shown) which cassette body 13 accommodates the magnetic tape 14 that is wound onto a supply reel 15 and a winding reel 16, and forms a tape path 17 along a rear surface of the lid 12. Also, at the front side portion of the bottom surface of the cassette body 13, a pole accommodating space 18 that is opened upon loading the tape cassette 10 is provided. The new-type tape cassette 20 includes a cassette body 23 that is made of a box structure 21, a front lid 22, and a bottom slide board (not shown) which cassette body 23 accommodates the magnetic tape 24 that is wound onto a supply reel 25 and a winding reel 26, and forms a tape path 27 along a rear surface of the lid 22. Also, at the front side portion of the bottom surface of the cassette body 23, a pole accommodating space 28 that is opened upon loading the tape cassette 20 is provided. It is noted that the new-type tape cassette 20 is arranged to have the same length A and width B dimensions as the existing-type tape cassette 10. The height C of the new-type tape cassette 20 is arranged to be 1.5 times the height C of the existing-type tape cassette 10. Also, it is noted that a recessed portion 29 is formed at the rear edge middle portion of the bottom surface of the box structure 21 of the new-type tape cassette 20.

The main chassis 500 of the streamer device 30 on which the existing-type tape cassette 10 and the new-type tape cassette 20 are loaded includes a supply reel axle unit 32, a winding axis unit 33, and a tape cassette identifying switch 34. The tape cassette loading mechanisms are arranged such that the height position of the bottom surface of the new-type tape cassette 20 upon being loaded corresponds to the loaded height position of the bottom surface of the existing-type tape cassette 10.

### 3. [Outline of Tape Loading Operations]

In the following, an overall description of tape loading operations of the streamer device 30 is given.

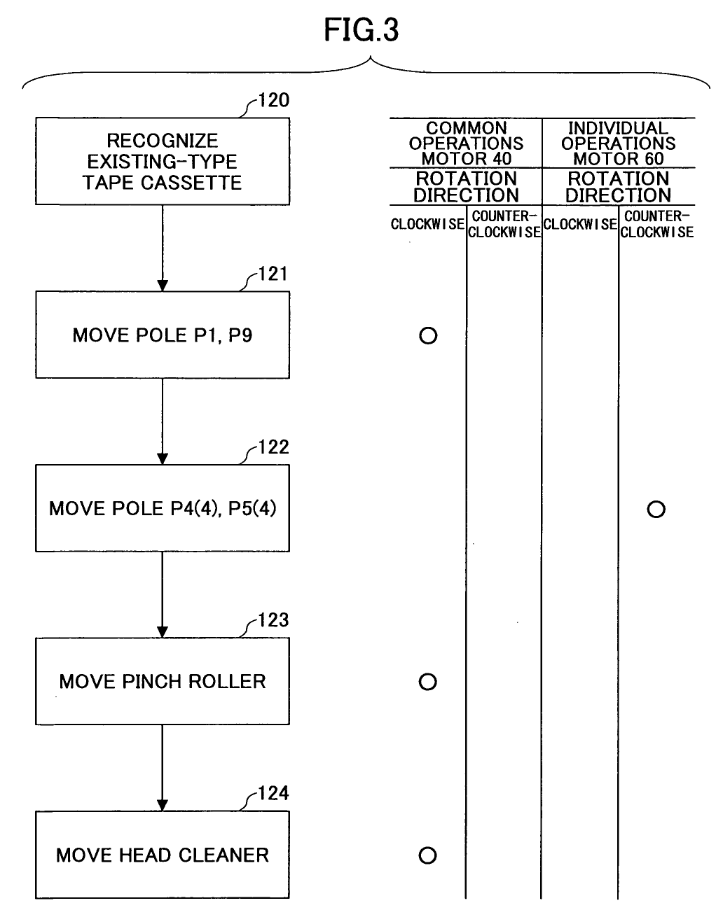

Referring to FIG. 3, when the existing-type tape cassette 10 is loaded, an existing-type tape cassette recognition operation 120, poles P1 and P9 moving operations 121, poles P4(4) and P5(4) moving operations 122, a pinch roller moving operation 123, and a head cleaner moving operation 124 are performed in this order.

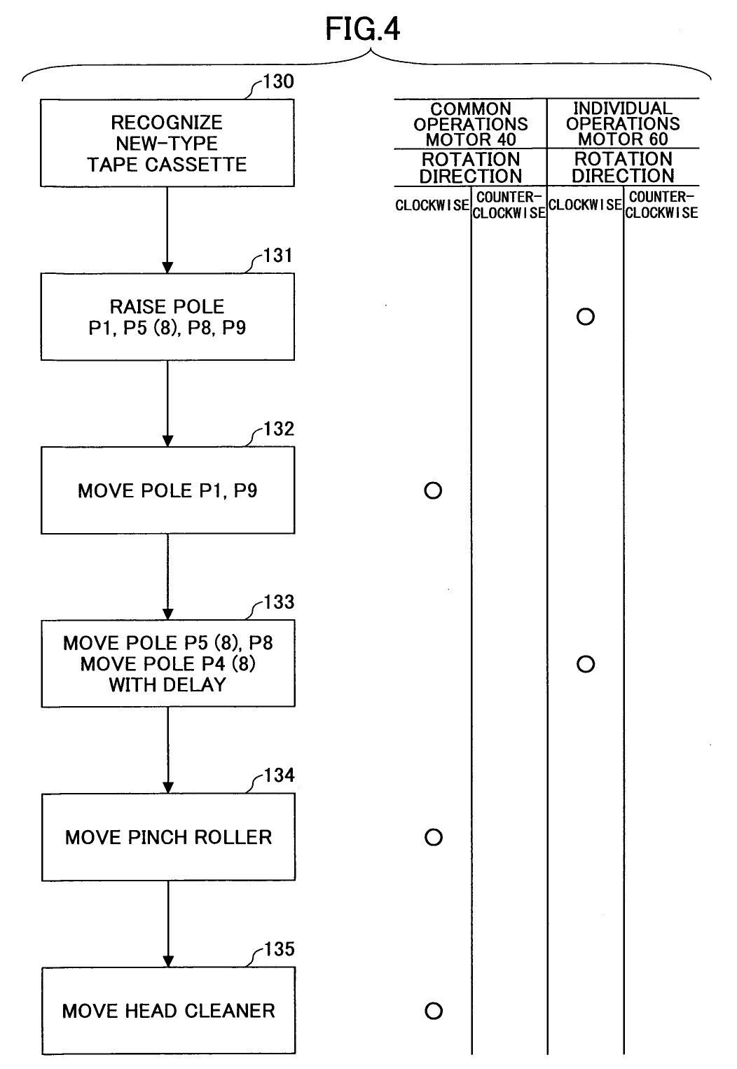

Referring to FIG. 4, when the new-type tape cassette 20 is loaded, a new-type tape cassette recognition operation 130, poles P1, P5(8), P8, and P9 raising operations 131, poles P1 and P9 moving operations 132, poles P5(8), P8, and P4(8) moving operations 133, a pinch roller moving operation 134, and a head cleaner moving operation 135 are performed in this order.

The poles P1 and P9 moving operations 121 and 132, the pinch roller moving operations 123 and 134, and the head cleaner moving operations 124 and 135 correspond to common operations, and are performed by rotating the common operations motor 40 in a clockwise direction.

The poles P4(4) and P5(4) moving operations 121 correspond to operations unique to the existing-type tape cassette 10. The poles P1, P5(8), P8, and P9 raising operations 131, and the poles P5(8), P8, and P4(8) moving operations 133 correspond to operations unique to the new-type tape cassette 20. These operations are performed by rotating the individual operations motor 50. Specifically, the operations 122 that are unique to the existing-type tape cassette 10 are performed by rotating the individual operations motor 50 in a counter-clockwise direction. The operations 131 and 133 that are unique to the new-type tape cassette 20 are performed by rotating the individual operations motor 50 in a clockwise direction. It is noted that the circular marks in FIGS. 3 and 4 indicate the motor that is driven and the rotating direction of the operating motor in each of the operations 121˜124 and 131˜135.

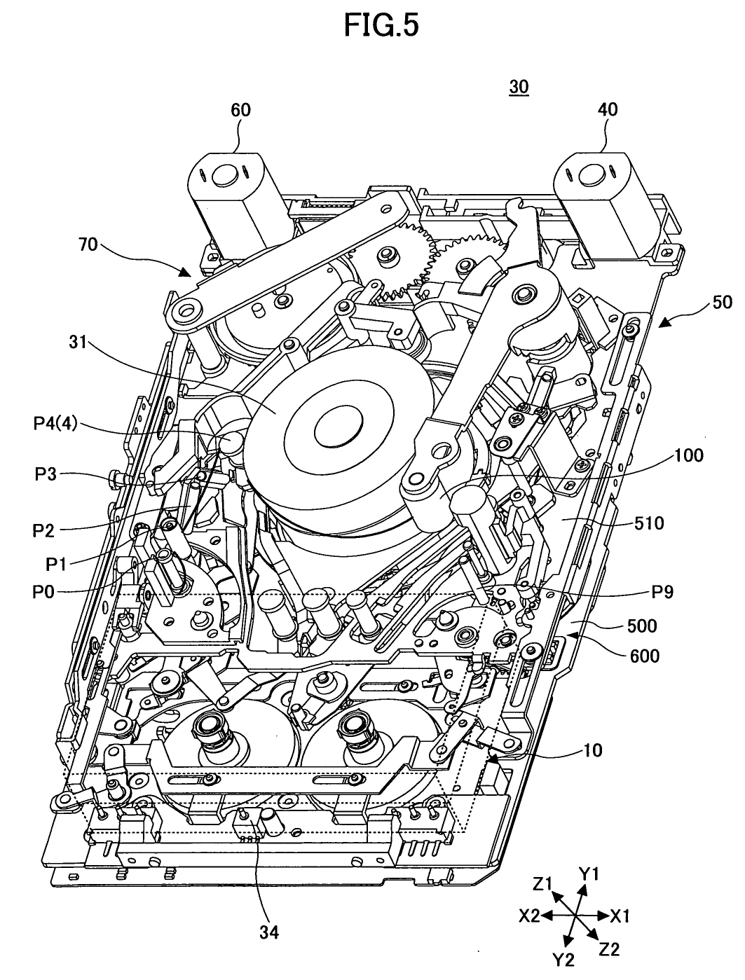

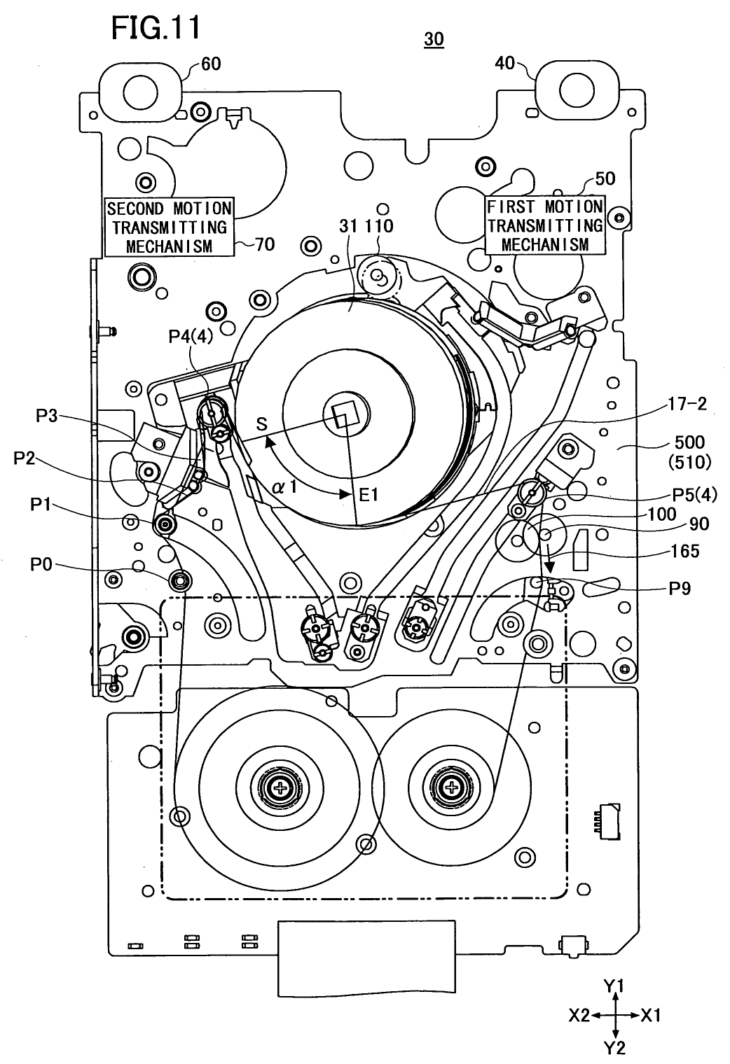

FIGS. 5 and 11 are diagrams illustrating the state of the streamer device 30 after the existing-type tape cassette 10 is loaded into the streamer device 30 and the tape loading operations 121, 122, and 123 of FIG. 3 are performed. As is shown in the drawings, the magnetic tape 14 forms a tape path 17-2 (see FIG. 11). Also, as is shown in conjunction with FIG. 7A, the magnetic tape 14 is guided by the tape guide 31c to be wound onto the rotating drum unit 31 over a winding angle α1 from a start position S to an end position E1 (e.g., around 90 degrees) in a diagonal direction, and as is shown in FIG. 7B, a rotating head scans the magnetic tape 14 in a direction indicated by arrow 162 so that information may be recorded on the magnetic tape 14 in the form of a track pattern 160 with angle θ. It is noted that the track pattern 160 corresponds to a track pattern with lower compatibility that is identical to the type of track pattern formed by an existing-type streamer device. FIG. 7B shows the opposite side of the magnetic film surface of the magnetic tape 14, that is, the Y2 side of the magnetic tape 14. The angle α1 corresponds to an angle range required for forming the track pattern 160 across substantially the entire width of the magnetic tape 14. The arrow 162 indicates the direction in which the rotating head scans the magnetic tape 14.

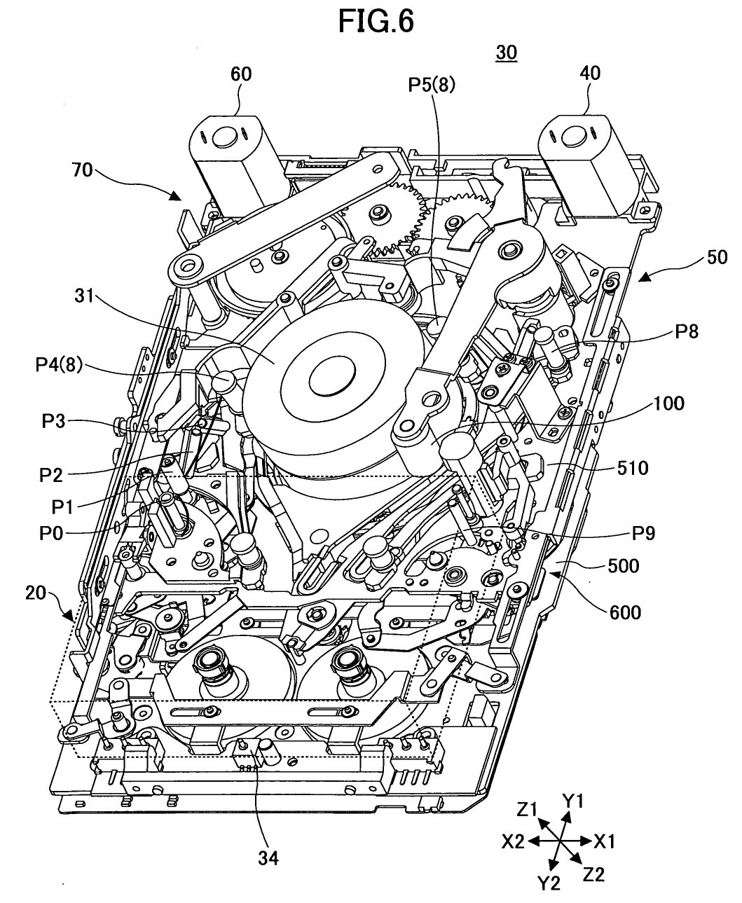

FIGS. 6 and 18 illustrate the state of the streamer device 30 after the new-type tape cassette 20 is loaded and the tape loading operations 131, 132, 133, and 134 of FIG. 4 are performed. As is shown in the drawings, the magnetic tape 24 forms a tape path 27-4 (see FIG. 18). Also, as is shown in conjunction with FIG. 7A, the magnetic tape 24 is guided by the tape guide 31c to be wound onto the rotating drum unit 31 over a winding angle α2 from a start position S to an end position E2 (e.g., around 180 degrees) in a diagonal direction, and as is shown in FIG. 7C, the rotating head scans the magnetic tape 24 in a direction indicated by arrow 163 to record information on the magnetic tape 24 in the form of a track pattern 161 with angle θ. The track pattern 161 corresponds to an extended track pattern of the track pattern 160, and in this way, the recording capacity of the new-type tape cassette 20 is increased with respect to that of the existing-type tape cassette 10. It is noted that FIG. 7C shows the opposite side of a magnetic film surface of the magnetic tape 24. The angle α2 corresponds to an angle range required for forming the track pattern 161 across substantially the entire width of the magnetic tape 24. The direction of arrow 163 shown in FIG. 7C corresponds to the direction of arrow 162 shown in FIG. 7B.

It is noted that the winding start position S for winding the magnetic tape 14 onto the rotating drum unit 31 and the winding start position S for winding the magnetic tape 24 onto the rotating drum unit 31 correspond to the same position.

### 4. [Tape Loading Operations for Existing-Type Tape Cassette 10]

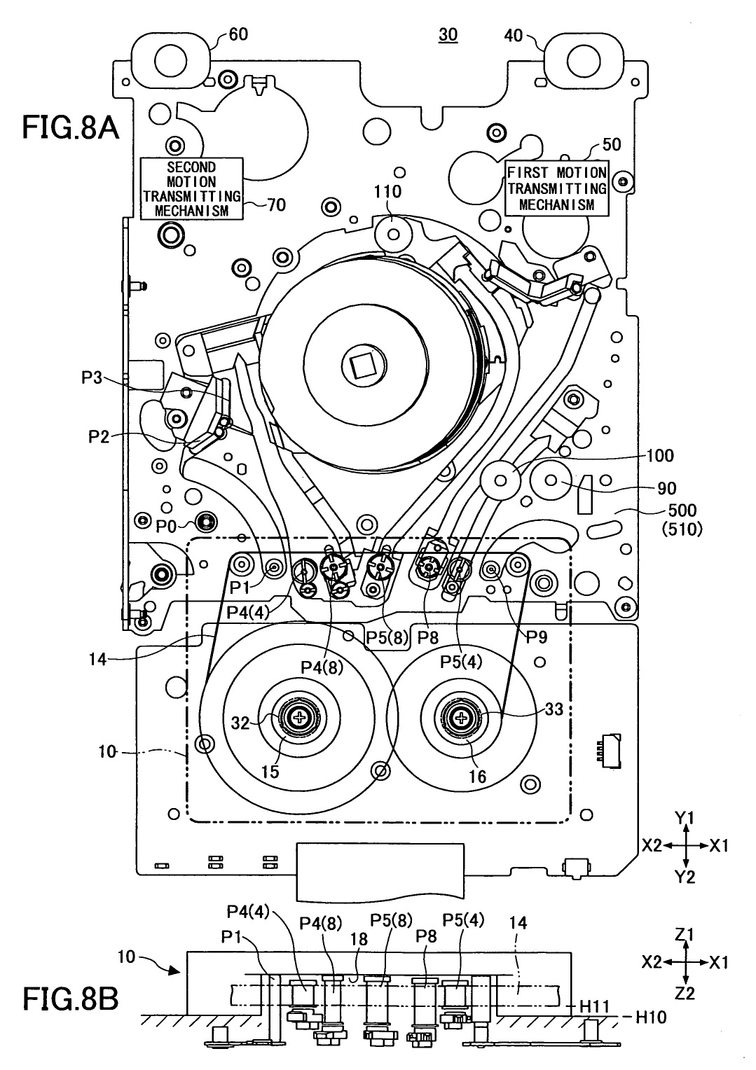

In the following, tape loading operations performed in a case where the existing-type tape cassette 10 is loaded are described with reference to FIGS. 8 through 11. It is noted that, in FIGS. 8-18, the main chassis 500 and the sub-chassis 510 are illustrated on the same plane for the sake of convenience.

Referring to FIG. 2, it is noted that the streamer device 30 includes paths 140˜145 through which the corresponding poles may move, and stoppers 151, 152, and 154.

FIGS. 8A and 8B illustrate the state of the streamer device 30 when the existing-type tape cassette 10 is loaded thereto. As is shown in FIG. 8B, the bottom surface of the existing-type tape cassette 10 is set to height H10 upon being loaded. When the existing-type tape cassette 10 is loaded, the slide board (not shown) is made to slide, the supply reel 15 and the winding reel 16 are engaged by the supply reel axle unit 32 and the winding reel axle unit 33, respectively, the lid 12 is opened, and the poles P1, P4(4), P4(8), P5(8), P8, P5(4), and P9 enter the pole accommodating space 18. The tape cassette identifying switch 32 is pushed by the cassette body 13, and the existing-type cassette recognition operation 120 is performed.

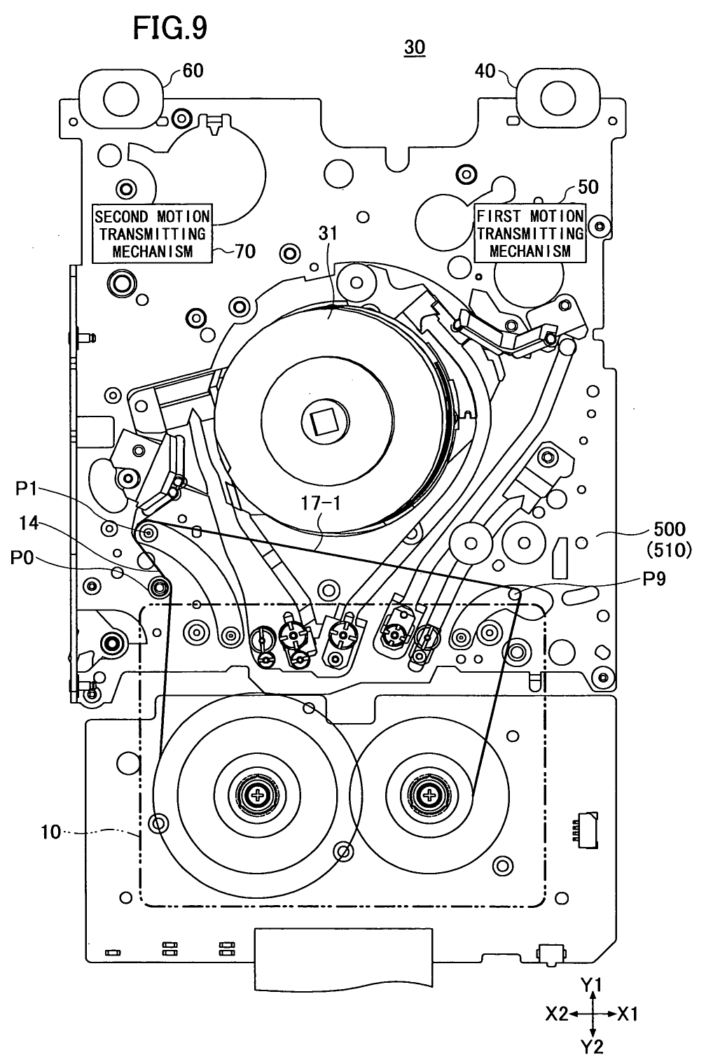

In response to the existing-type cassette recognition operation 120, first, as is shown in FIG. 9, the poles P1 and P9 moving operations 121 are performed. In FIG. 9, the common operations motor 40 is rotated in a clockwise direction to operate the first motion transmitting mechanism 50. Accordingly, the pole P1 is moved toward the X2 direction, the pole P9 is moved toward the X1 direction, and the magnetic tape 14 is pulled out of the tape cassette 10 to form a first tape path 17-1.

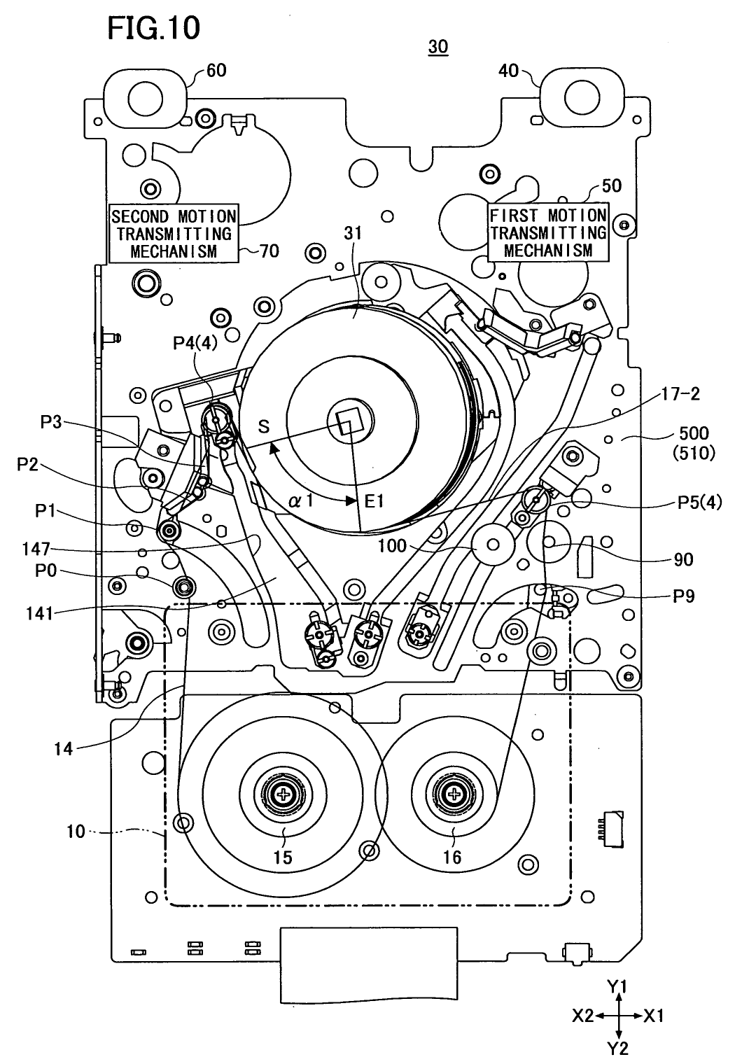

Then, as is shown in FIG. 10, the poles P4(4) and P5(4) moving operations 122 are performed. In FIG. 10, the individual operations motor 60 is rotated in a clockwise direction to operate the second motion transmitting mechanism 70. Accordingly, the pole P4(4) engages a guide rail portion 147 at the X2 side of the path 141 (see FIG. 28), and moves along the path 141 toward the Y1 direction until reaching the stopper 151. The pole P5(4) is moved along the path 144 toward the Y1 direction until reaching stopper 154. Then, the poles P4(4) and P5(4) pull the magnetic tape 14 further to extend the tape path 17-1. In turn, the magnetic tape 14 is wound around the rotating drum unit 31 over an angle α1 from the position S to the position E1 in a diagonal direction, and comes into contact with the capstan 90 to form a second tape path 17-2. It is noted that the pole P5(4) and the magnetic tape 14 pass on the Z2 side of the pinch roller 100 to avoid interfering with the pinch roller 100.

In the second tape path 17-2, the magnetic tape 14 extends from the supply reel 15 of the existing-type tape cassette 10, is guided by the poles P0 and P1, is guided and twisted by the poles P2 and P3, is wound onto the rotating drum unit 31 between the poles P4(4) and P5(4), and is guided by the capstan 90 and the pole P9 to enter the winding reel 16 of the existing-type tape cassette 10.

Then, as is shown in FIG. 11, the pinch roller moving operation 123 is performed. In FIG. 11, the common operations motor 40 is rotated in a clockwise direction to operate the first motion transmitting mechanism 50. Accordingly, the pinch roller 100 is moved downward toward the Z2 direction and enters the second tape path 17-2. Then, the pinch roller 100 is moved in the X1 direction to be pushed toward the capstan 90, and the magnetic tape 14 starts running in a direction indicated by arrow 139 so that an information recording or reproducing operation may be started.

It is noted that in the illustrated embodiment, the magnetic tape 14 is wound onto the rotating drum unit 31 until reaching the winding end position E1. The magnetic tape 14 is separated from the peripheral surface of the rotating drum unit 31 immediately before the rotating head scanning the magnetic tape 14 in a diagonal direction reaches the top edge of the magnetic tape 14. Such an arrangement prevents the rotating head from scanning across the top edge of the magnetic tape 14, and thereby, prevents damage to the magnetic tape 14 resulting from the rotating head scanning across the top edge of the magnetic tape 14.

Then, the head cleaner moving operation 124 is performed. As is shown in FIG. 11, the common operations motor 40 is rotated in a clockwise direction to operate the first motion transmitting mechanism 50. Accordingly, the head cleaner 110 is moved to a position indicated by a two-dotted line in the drawing to come into contact with the rotating drum unit 31, and the rotating head is thus cleaned.

It is noted that tape unloading operations are performed by the above-described operations in reverse order, in each of which operations the components being moved are moved in reverse directions with respect to the moving directions indicated above.

### 5. [Tape Loading Operations for New-Type Tape Cassette 20]

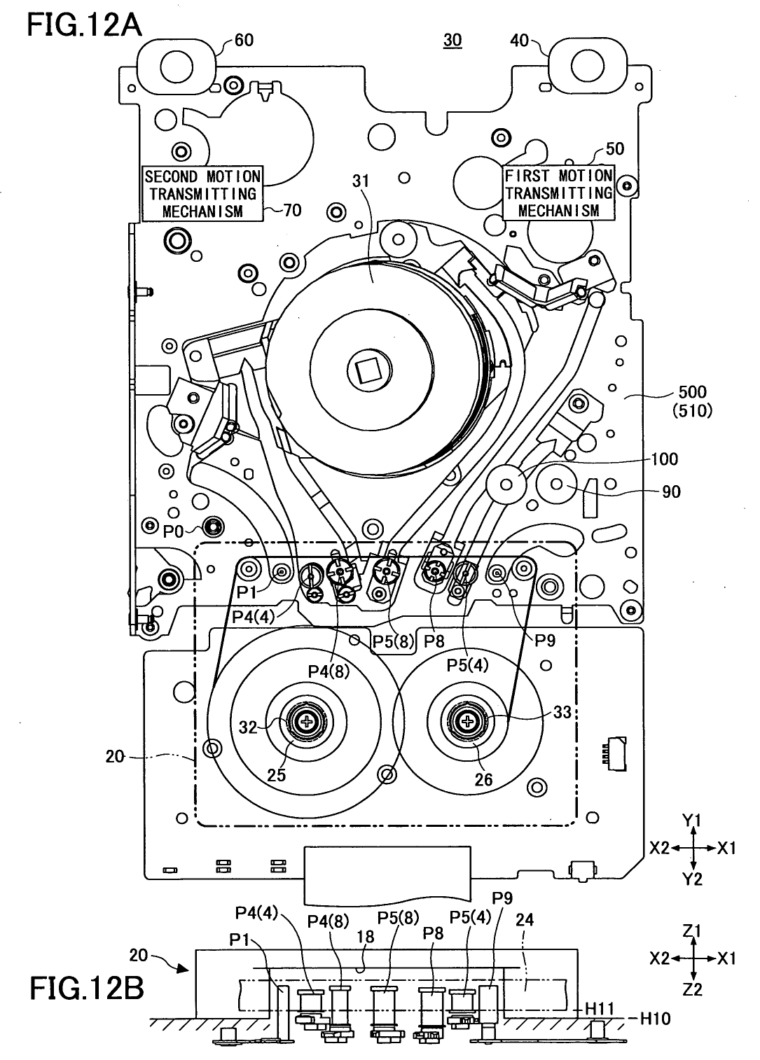

In the following, tape loading operations that are performed in a case where the new-type tape cassette 20 is loaded into the streamer device 30 are described with reference to FIGS. 12 through 18.

FIGS. 12A and 12B illustrate the state of the streamer device 30 when the new-type tape cassette 20 is loaded thereto. As is shown in FIG. 12B, the bottom surface of the new-type tape cassette 20 is set to height H10 upon being loaded. When the new-type tape cassette 20 is loaded, the slide board (not shown) is made to slide, the supply reel 25 and the winding reel 26 are engaged by the supply reel axle unit 32 and the winding reel axle unit 33, respectively, the lid 22 is opened, and the poles P1, P4(4), P4(8), P5(8), P8, P5(4), and P9 enter the pole accommodating space 28. In this case, the recessed portion 29 is arranged to face against the tape cassette identifying switch 32 so that the tape identifying switch 32 is not pushed, and thus, the new-type cassette recognition operation 130 is performed. Also, it is noted that when the new-type tape cassette 20 is loaded, the bottom edge of the magnetic tape 24 is positioned at height H11, which corresponds to the loaded height position of the bottom edge of the magnetic tape 14 of the existing-type tape cassette 10.

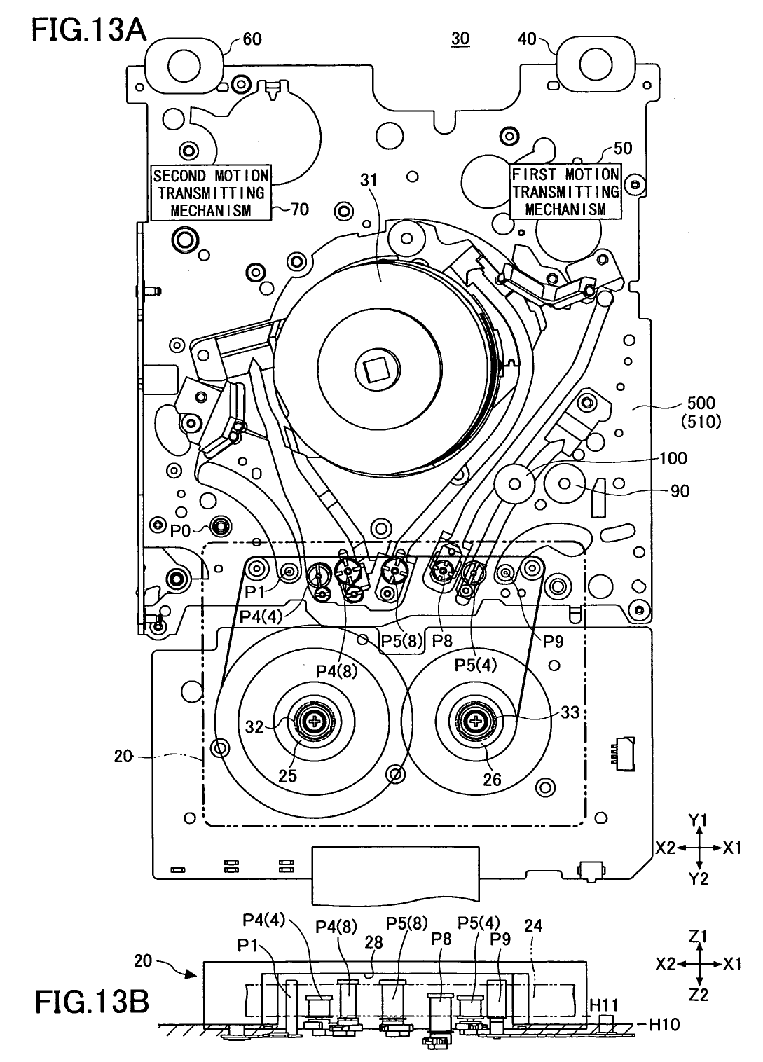

In response to the new-type cassette recognition operation 130, first, as is shown in FIGS. 13A and 13B, the poles P1, P5(8), P8, and P9 raising operations 131 are performed. In FIGS. 13A and 13B, the individual operations motor 60 is rotated in a counter-clockwise direction so that the second motion transmitting mechanism 70 is operated. Accordingly, a pole raising/lowering mechanism 280 and other related components (see FIG. 30) are operated so that the poles P1, P5 (8), P8, and P9 may be raised in the Z1 direction within the pole accommodating space 28 to span across substantially the entire width of the 8 mm-width magnetic tape 24. It is noted that when the poles are not arranged to face against the entire width of the magnetic tape 24 upon engaging the magnetic tape 24 to pull the magnetic tape 24 out of the new-type tape cassette 20, the engagement between the poles and the magnetic tape 24 may be unstable and may thereby cause damage to the magnetic tape 24. On the other hand, when the poles P1, P5 (8), P8, and P9 are arranged to face against the entire width of the 8 mm-width magnetic tape 24, the magnetic tape 24 may be engaged without causing damage thereto.

It is noted that the upper ends of the moving poles P1, P4(4), P4(8), P5(8), P8, P5(4), and P9 are arranged to be positioned at the same height, and the longer poles P1, P4(8), P5(8), P8, and P9 are normally set to lowered positions (in the Z2 direction) so that the existing-type tape cassette 10 may be loaded at the same height as the loading height position of the new-type tape cassette 20 without interfering with the longer poles P1, P4(8), P5 (8), P8, and P9. Accordingly the operations 131 are performed when the new-type tape cassette 20 is loaded into the streamer device 30 in order to adjust the heights of the poles for use in the new-type tape cassette loading operations.

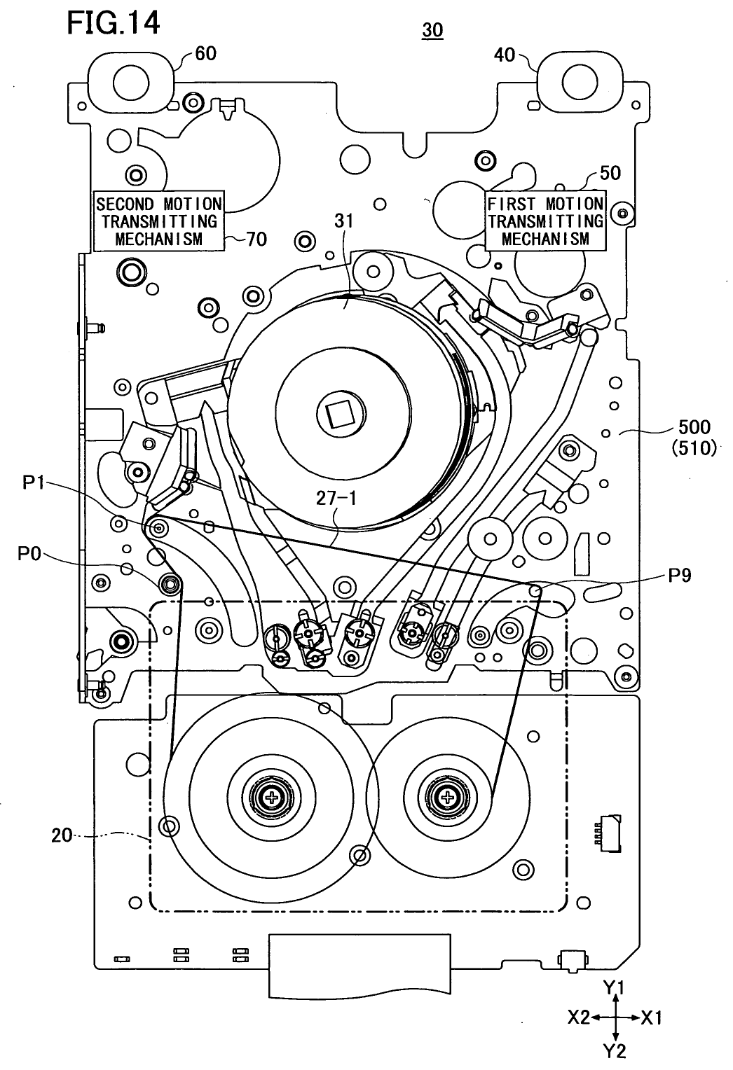

Then, as is shown in FIG. 14, the poles P1 and P9 moving operations 132 are performed. In FIG. 14, the common operations motor 40 is rotated in a clockwise direction to operate the first motion transmitting mechanism 50. Accordingly, the pole P1 is moved toward the X2 direction, the pole P9 is moved toward the X1 direction, and the magnetic tape 24 is pulled out of the tape cassette 20 to form a first tape path 27-1.

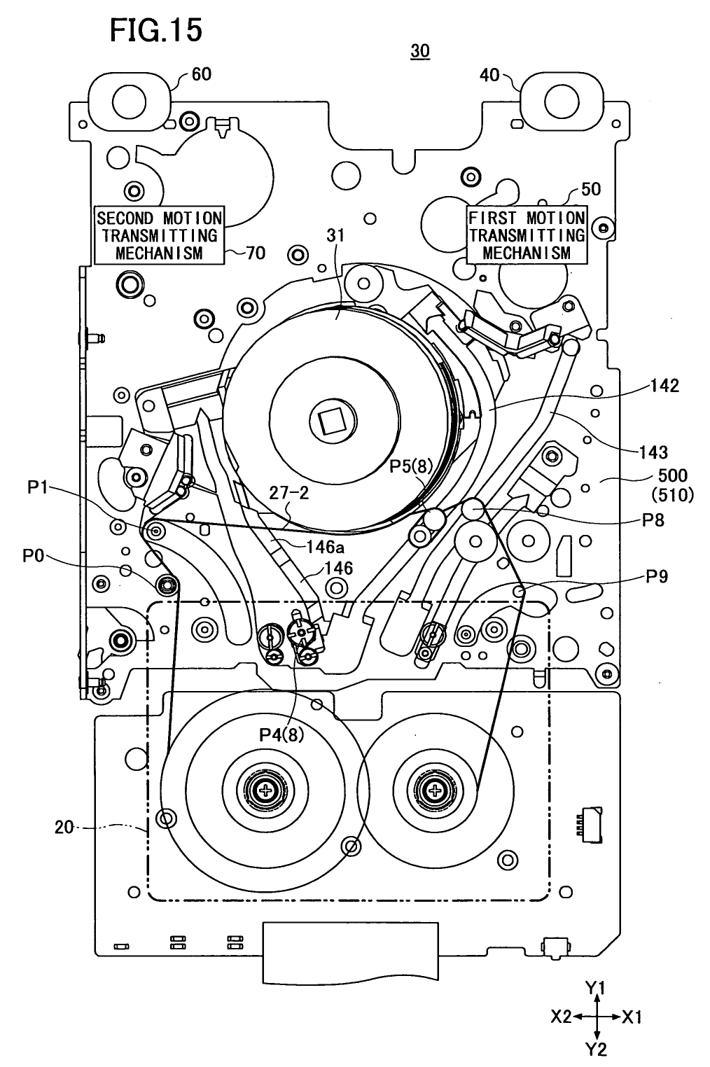

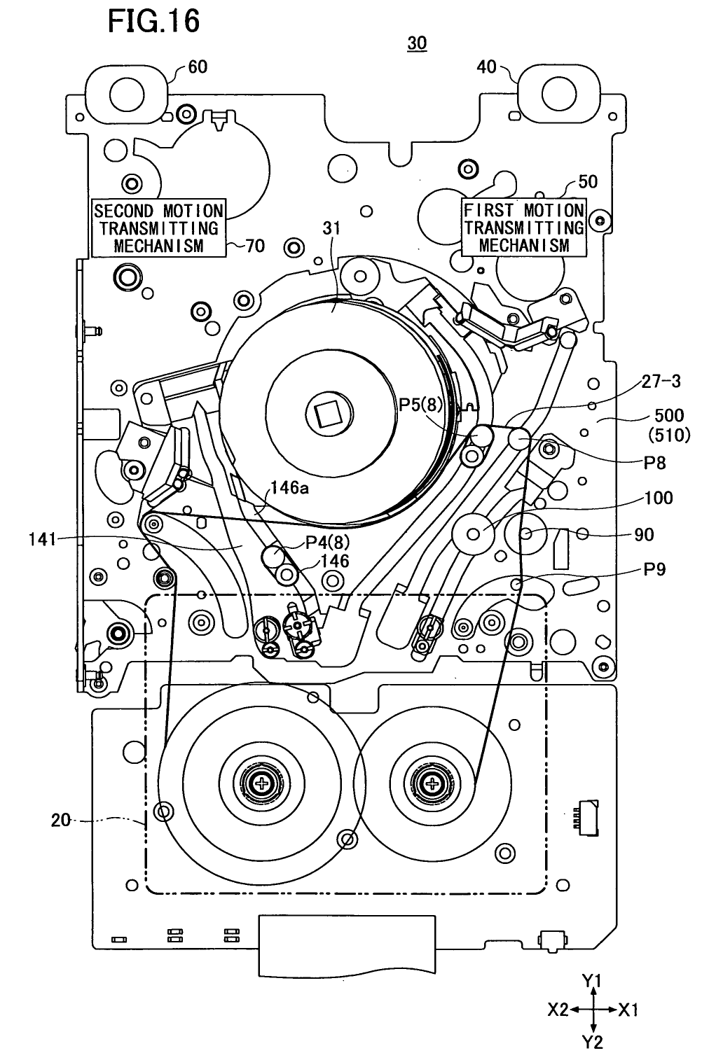

Then, the P5(8), P8, and P4(8) moving operations are performed. First, as is shown in FIG. 15, the individual operations motor 60 is rotated in a counter-clockwise direction to operate the second motion transmitting mechanism 70. Accordingly, the poles P5(8) and P8 are moved toward the Y1 direction along paths 142 and 143, respectively, to pull out the magnetic tape 24 further. In turn, the first tape path 27-1 is extended so that the magnetic tape 24 comes into contact with the rotating drum unit 31 to form a second tape path 27-2. Then, as is shown in FIG. 16, after a certain delay, the pole P4(8) is moved toward the Y1 direction. The pole P4(8) engages a guide rail portion 146 at the X1 side of path 141 to be moved along this guide rail portion 146 toward the Y1 direction. The guide rail portion 146 includes a sloped portion 146a sloping in the Z1 direction, and the pole P4(8) is raised in the Z1 direction while being moved toward the Y1 direction to be arranged at a height corresponding to the width of the magnetic tape 24. The pole P4(8) moves toward the Y1 direction to engage the magnetic tape 24, and continues moving with the magnetic tape 24 engaged thereto.

In the following, the reason for delaying the start of the operation for moving the pole P4(8) is explained. First, in order to reduce the size of the streamer device 30, a dedicated path is not provided for the pole P4(8), and the pole P4(8) uses the path 141, which is also used by the pole P4(4). Second, in this respect, the pole P4(8) is arranged to be raised while being moved. Third, the magnetic tape 24 is preferably distanced as far away (in the Y1 direction) as possible from the new-type tape cassette 20 so that the pole P4(8) may be completely raised before reaching the magnetic tape 24.

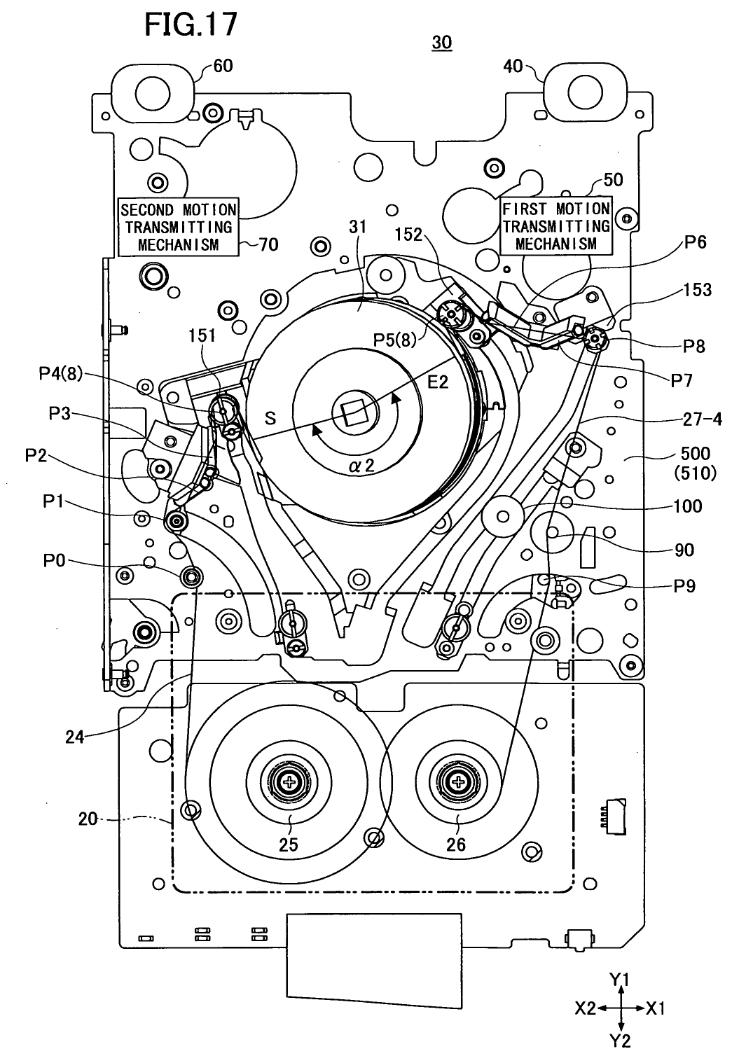

As shown in FIG. 17, the poles P4(8), P5(8), and P8 reach the stoppers 151, 152, and 153, respectively, at substantially the same time. The second tape path 27-2 is further extended to form a third tape path 27-3 as is shown in FIG. 16, which third tape path 27-3 is further extended so that the magnetic tape 24 is wound around the rotating drum unit 31 over a winding angle α2 from the start position S to the end position E2 in a diagonal direction and contacts the capstan 90 to form a fourth tape path 27-4 as is shown in FIG. 17. It is noted that the pole P8 and the magnetic tape 24 pass the Z2 side of the pinch roller 100 without interfering with the pinch roller 100.

In the fourth tape path 27-4, the magnetic tape 24 extends from the supply reel 25 side of the new-type tape cassette 20, is guided by the poles P0 and P1, is guided and twisted by the poles P2 and P3, is wound onto the rotating drum unit 31 between the poles P4(8) and P5(8), is guided and twisted by the poles P6 and P7, and is guided by the pole P8, the capstan 90, and the pole P9, to then enter the winding reel 26 of the new-type tape cassette 20.

Then, as is shown in FIG. 18, the pinch roller moving operation 134 is performed. In FIG. 18, the common operations motor 40 is rotated in a clockwise direction to operate the first motion transmitting mechanism 50. Accordingly, the pinch roller 100 is moved downward toward the Z2 direction and enters the fourth tape path 27-4. Then, the pinch roller 100 is moved in the X1 direction to be pushed toward the capstan 90, and the magnetic tape 24 starts running in the direction indicated by arrow 139 so that an information recording or reproducing operation may be started.

It is noted that in the illustrated embodiment, the magnetic tape 24 is wound onto the rotating drum unit 31 until reaching the winding end position E2. The magnetic tape 24 is separated from the peripheral surface of the rotating drum unit 31 immediately before the rotating head scanning the magnetic tape 24 in a diagonal direction reaches the top edge of the magnetic tape 24. Such an arrangement prevents the rotating head from scanning across the top edge of the magnetic tape 24, and thereby prevents damage to the magnetic tape 24 resulting from the rotating head scanning across the top edge of the magnetic tape 24.

Then, the head cleaner moving operation 135 is performed. As is shown in FIG. 18, the common operations motor 40 is rotated in a clockwise direction to operate the first motion transmitting mechanism 50. Accordingly, the head cleaner 110 is moved to a position indicated by a two-dotted line in the drawing to contact the rotating drum unit 31, and the rotating head is thus cleaned.

It is noted that tape unloading operations are performed by the above-described operations in reverse order, in each of which operations the components being moved are moved in reverse directions with respect to the moving directions indicated above.

Also, it is noted that in the illustrated embodiment, the magnetic tape 14/24 is twisted by the stationary poles P2 and P3 before being wound onto the rotating drum unit 31, and the perpendicular pole P4(4/8) moves to pull out the magnetic tape 14/24 and position the magnetic tape 14/24 alongside the rotating drum unit 31 and determines the position of the magnetic tape 14/24 at the entrance side of the rotating drum unit 31. Also, the magnetic tape 14/24 is twisted by the stationary poles P6 and P7 after separating from the rotating drum unit 31, and the pole P5(4/8) moves to pull out the magnetic tape 14/24 and determines the position of the magnetic tape 14/24 at the exit side of the rotating drum unit 31. By providing such an arrangement, the moving poles P1, P4(4), P4(8), P5(8), P8, P5(4), and P9 may be accommodated within the pole accommodating space 18/28.

### 6. [Common Operations Mechanism]

In the following, the common operations motor 40, the first motion transmitting mechanism 50, and operations and mechanisms that are controlled by the power transmitted from the first motion transmission mechanism 50 are described.

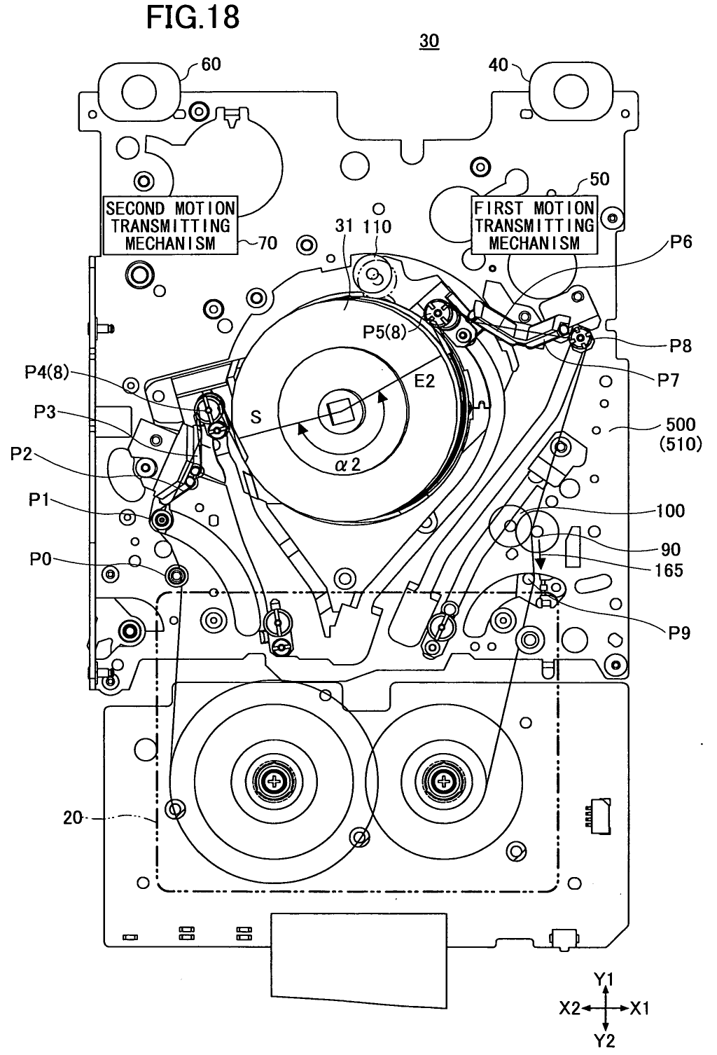

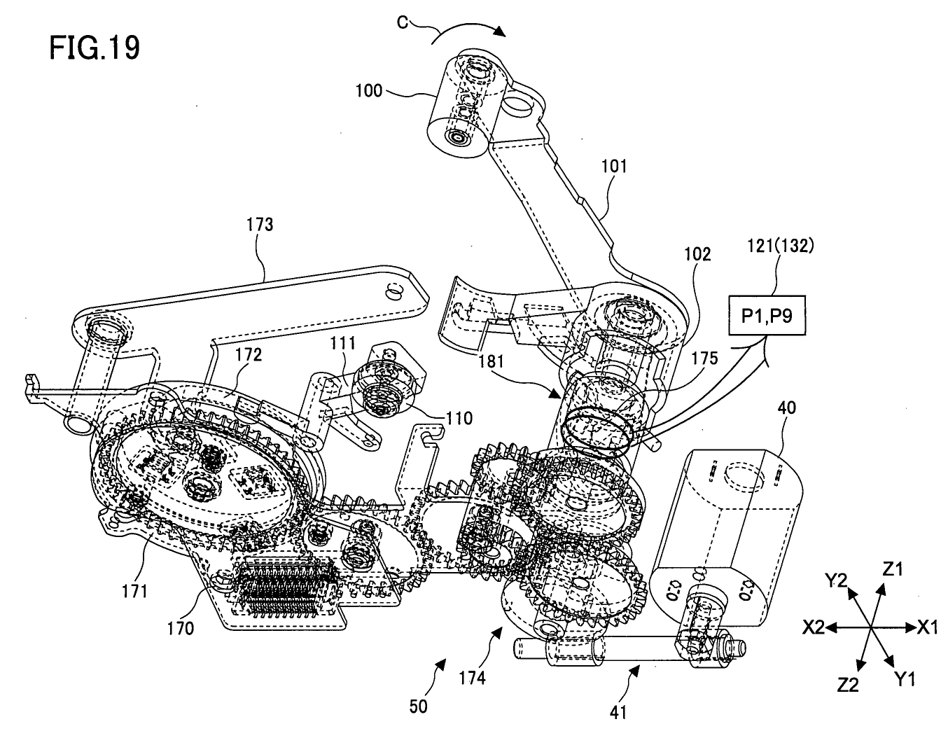

FIG. 19 illustrates the state of the first motion transmitting mechanism 50 when the streamer device 30 is in the state illustrated by FIG. 1 (i.e., when a tape cassette is not loaded). FIG. 19 is a perspective view of an underside of the first motion transmitting mechanism 50. According to this drawing, the first motion transmitting mechanism 50 includes an operation state detection substrate 170 that is provided with plural photo detectors, and a common mode switching gear 171 that has a mode switching pattern formed on its lower surface and a cam 172 provided on its upper surface. The operation state detection substrate 170 optically detects a rotation angle position of the common mode switching gear 171 based on the combination of outputs from the photo detectors, and detects the operation state of the first motion transmitting mechanism 50. In turn, as is shown in FIG. 2, a detection signal is transmitted from the operation state detection substrate 170 to a control circuit 82, and a control signal is transmitted from the control circuit 82 to a motor drive circuit 80 so that the motor drive circuit 80 may be operated. In turn, the common operations motor 40 is activated and deactivated at predetermined times to perform the poles P1 and P9 moving operations 121, 131, the pinch roller moving operations 123, 134 and the head cleaner moving operations 124, 135 of FIGS. 3 and 4. The first motion transmitting mechanism 50 also includes a tape cassette loading arm 173 that is rotated by the cam unit 172 and is configured to operate a tape cassette loading mechanism (not shown). It is noted that in the illustrated embodiment, the common mode switching gear itself is provided with a mode switching function, and in this way, the mode position may be accurately determined compared to an arrangement in which the mode switching function is provided elsewhere.

### 7. [Common Operations]

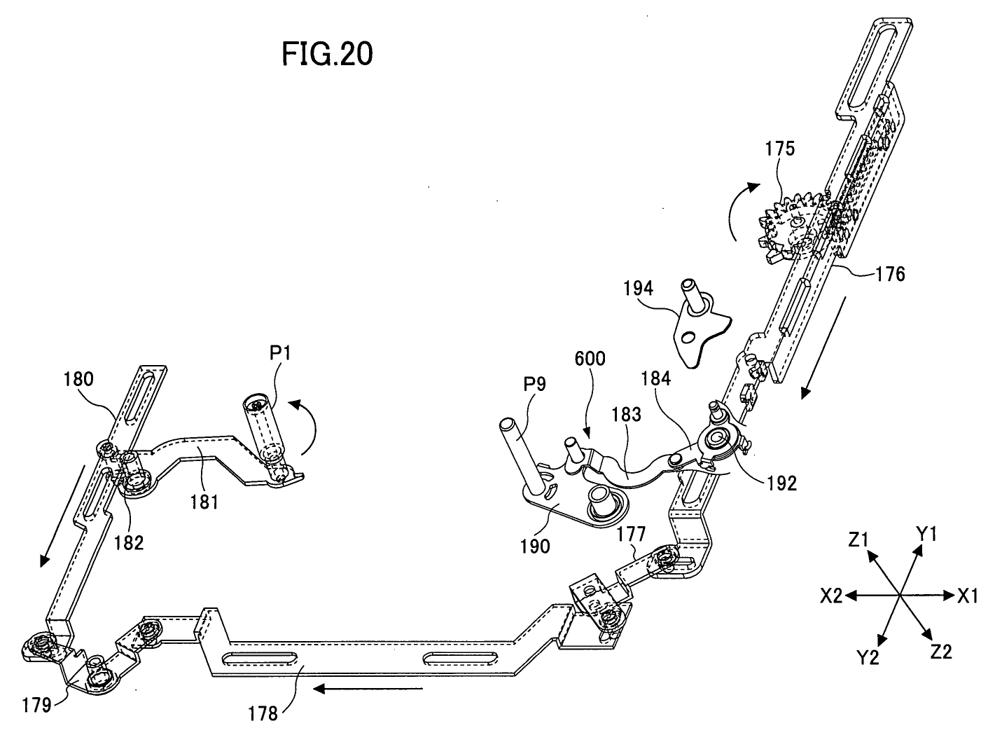

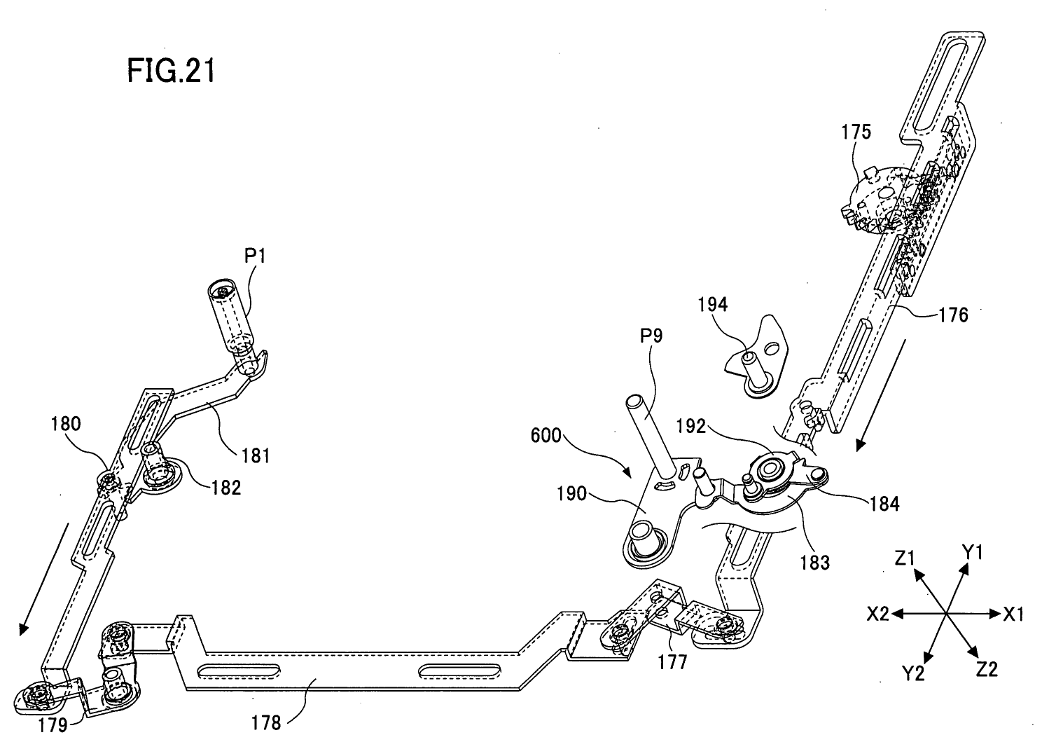

### [Poles P1 and P9 Moving Operations 121/131] (See FIGS. 20 and 21)

The pole P1 is fixed to the tip portion of arm 181. The pole P9 (tape guiding member) is supported in an upright manner on the upper surface of a supporting base 190 configured to move (travel) on the main chassis 500.

The pole P9 is driven by a tape guide moving mechanism 600. The tape guide moving mechanism 600 includes, for example, a slide lever 176, a supporting base 190, a first arm 183, a second arm 184, a spring receiving member 192, a torsion spring (not visible in FIG. 20), and an oscillating member 195. The tape guide moving mechanism 600 is described in detail below.

When the common operations motor 40 is driven, a gear mechanism 174 is driven via a worm gear 41 (see FIG. 19), a drive gear 175 is rotated in a clockwise direction (see FIG. 20), a slide lever (driving force transmitting member) 176 is made to slide in the Y2 direction, and a slide lever 180 is made to slide in the Y2 direction via a rotating lever 177, a link 178, and a rotating lever 179 (see FIG. 21). In response to the sliding motion of the slide lever 180, the arm 181 is rotated in a counter-clockwise direction around the stationary post 186 and the pole P1 is thus moved. Also, in response to the sliding motion of the slide lever 176, the arms 184 and 183 are rotated in a clockwise direction around the stationary post 187 and the pole P9 is thus moved.

### [Pinch Roller Moving Operation 123/134] (See FIG. 19)

When the common operations motor 40 is driven, a cylinder portion 102 at the base of a pinch roller support arm 101 is guided by a perpendicular trench to be lowered in the Z2 direction, and upon reaching the end of the perpendicular trench, the pinch roller support arm 101 is rotated in a direction indicated by arrow 193. In this way, the pinch roller 100 is pushed toward the capstan 90.

### [Head Cleaner Moving Operation 124/135] (See FIG. 19)

When the common operations motor 40 is driven, the common mode switching gear 171 is rotated, and an arm member 111 is rotated by the cam 172 that is provided at the common mode switching gear 171 so that the head cleaner 110 is moved to come into contact with the rotating drum unit 31.

It is noted that after the common mode switching gear 171 is rotated and the head cleaner 110 is moved accordingly, the common mode switching gear 171 may be rotated in a reverse direction, and the above described operations may be performed in reverse order (i.e., 124/135, 123/134, 121/131) in which case the components moved in each operation are moved in reverse directions with respect to the moving directions indicated above. In this way, the mechanisms described above may be set back to their initial states.

It is noted that a detailed description of the individual operations mechanism and individual operations by the individual operations motor 60 and the second motion transmitting mechanism 70 is omitted.

In the following, the poles P1, P5(8), P8, and P9 raising operations 131, performed when the new-type tape cassette 20 is loaded, is explained.

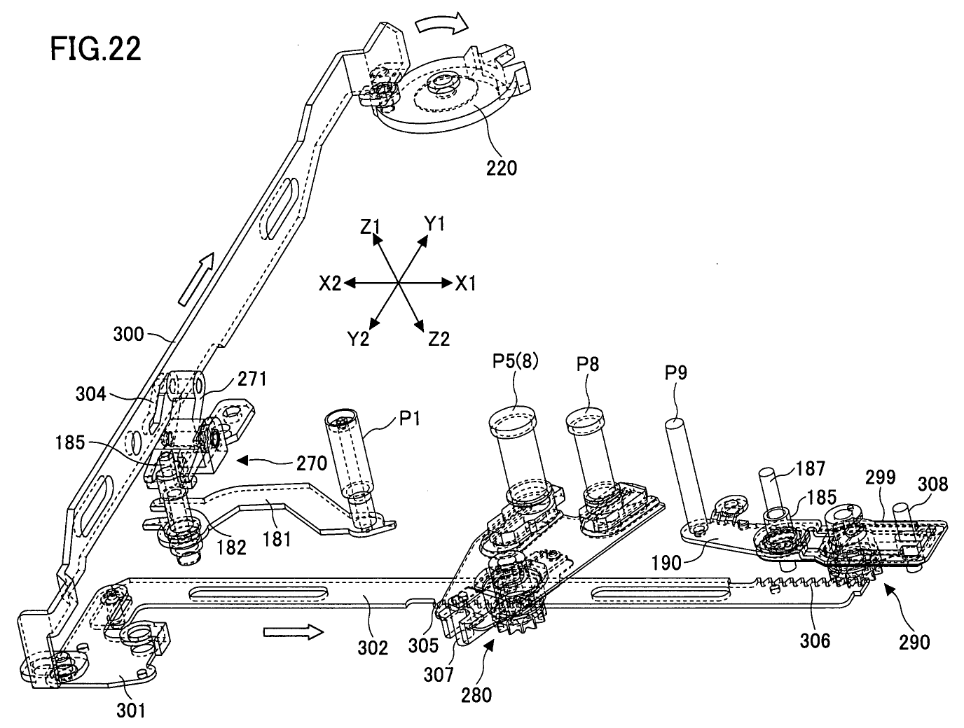

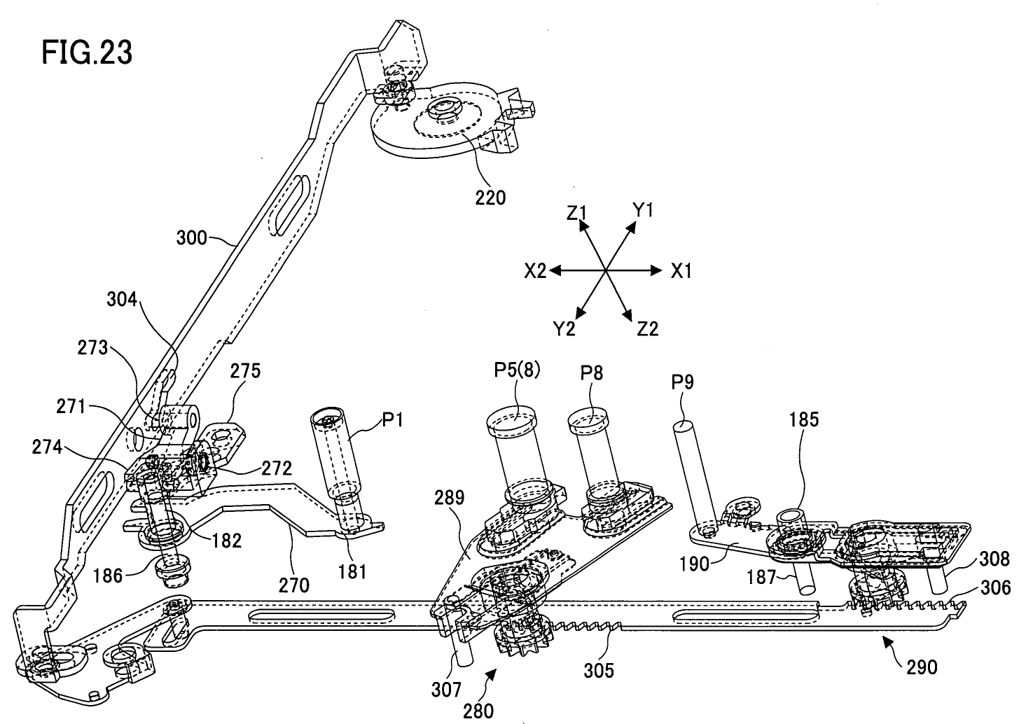

### [Poles P1, P5(8), P8, and P9 Raising Operation 131](See FIGS. 22 and 23)

FIG. 22 shows an initial state of the poles P1, P5(8), P8, and P9 raising operations 131 where the poles P1, P5(8), P8, and P9 are in a lowered state. FIG. 23 shows a completed state of the poles P1, P5(8), P8, and P9 raising operations 131 where the poles P1, P5(8), P8, and P9 are in a raised state.

When the second drive gear 220 is rotated in a clockwise direction by the individual mode switching gear 200, a slide lever 300 is made to slide in the Y1 direction, and a slide lever 302 is made to slide in the X1 direction via a rotating lever 301. The slide lever 300 includes a cam trench 304, and the slide lever 302 includes racks 305 and 306.

It is noted that a see-saw type pole raising/lowering mechanism 270 is provided for the pole P1, a spiral cam type pole raising/lowering mechanism 280 is provided for the poles P5(8) and P8, and a spiral cam type pole raising/lowering mechanism 290 is provided for the pole P9.

The pole raising/lowering mechanism 270 includes a lever 271 having a center axle 272 that is supported by a bracket 275 to oscillate back and forth. A pin 273 at the Y1 side end of the lever 271 is engaged with the cam trench 304 of the slide lever 300, and a forked portion at the Y2 side end of the lever 271 is connected to the sleeve 182.

When the slide lever 300 is made to slide in the Y1 direction, the lever 271 is rotated by the cam trench 304 in a direction that causes the forked portion 274 to be raised, and the sleeve 182 is moved in the Z1 direction along the stationary post 186 so that the pole P1 is raised (see FIG. 23).

It is noted that further details regarding the structures of the pole raising/lowering mechanisms 280, 290 illustrated in FIGS. 22 and 23 are omitted. Although a part of the tape guide moving mechanism 600 is illustrated in FIGS. 22 and 23, the structure of the tape guide moving mechanism 600 is described in detail below with reference to FIG. 24 and drawings following FIG. 24.

Next, the tape guide moving mechanism 600 according to an embodiment of the present invention is described in detail with reference to FIGS. 24 through 37. The tape guide mechanism 600 is a mechanism for forming the first tape path 17-1 (see FIGS. 9 and 14) by using the pole P9 (tape guide member) to pull out the magnetic tape 14, 24 from the pole accommodating space 18, 28 formed in the tape cassettes 10, 20.

FIG. 24 is a perspective view showing a state before a tape loading operation of the tape guide moving mechanism 600. FIG. 25 is a perspective view showing a state after a tape loading operation of the tape guide moving mechanism 600.

In the tape guide moving mechanism 600, the slide lever 176 sliding in the Y1-Y2 directions in accordance with the driving of the common operations motor 40 and the oscillating member 194 are provided on the upper surface side of the sub-chassis 510 as shown in FIG. 24. The other components of the tape guide moving mechanism 600 are provided on the lower surface side of the sub-chassis 510. Furthermore, the pole P9 standing upright on the supporting base 190 is inserted through an arc-shaped opening formed in the sub-chassis 510 so that the pole P9 protrudes from the sub-chassis 510.

As shown in FIG. 25, the tape loading operation of the tape guide moving mechanism 600 causes the pole P9 to move in a clockwise direction along the arc-shaped opening 520 until the pole P9 reaches a final tape loading position, thereby forming the first tape path 17-1 (see FIGS. 9 and 14).

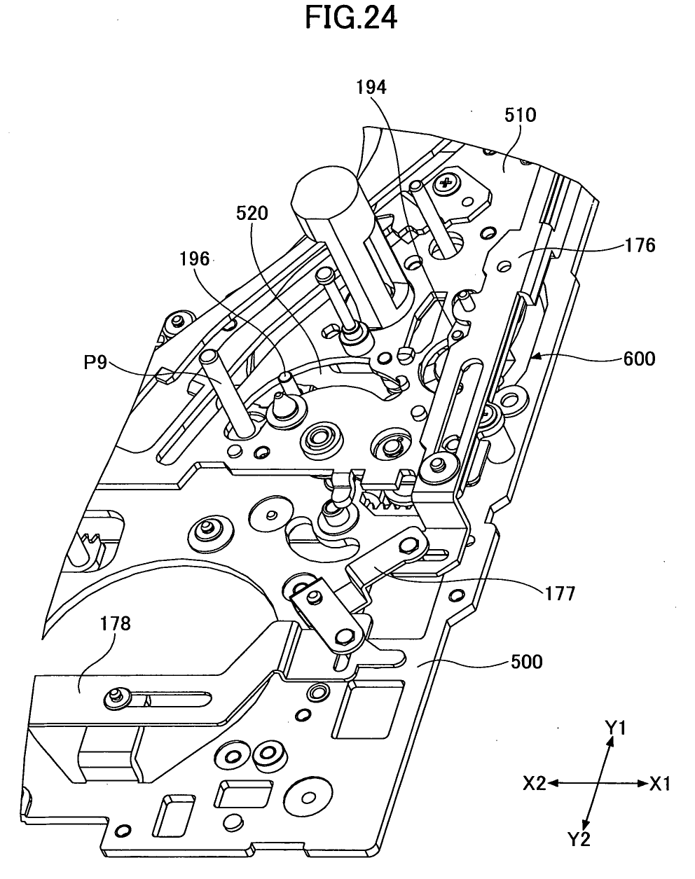

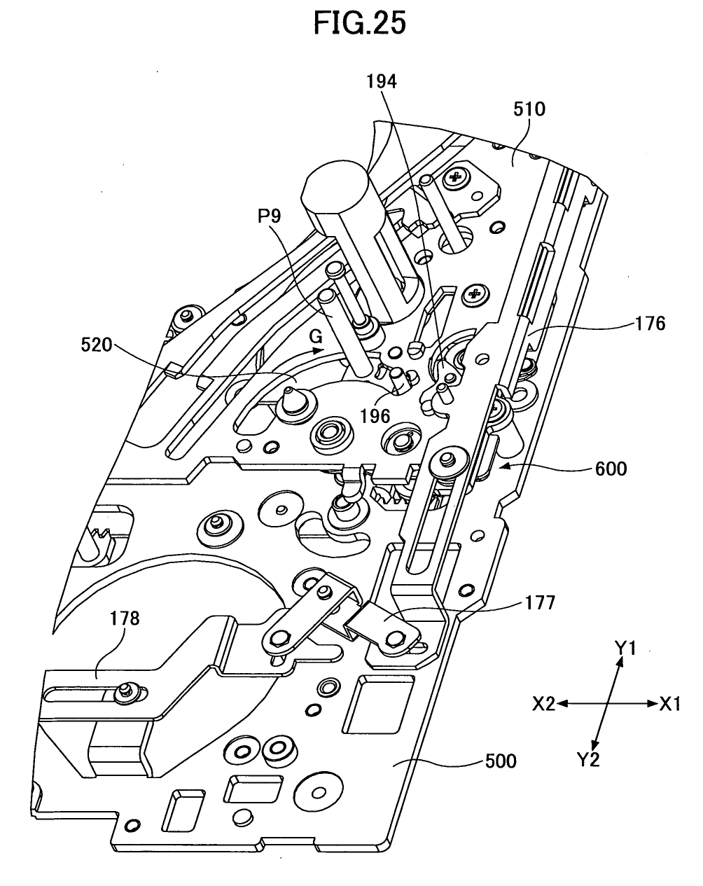

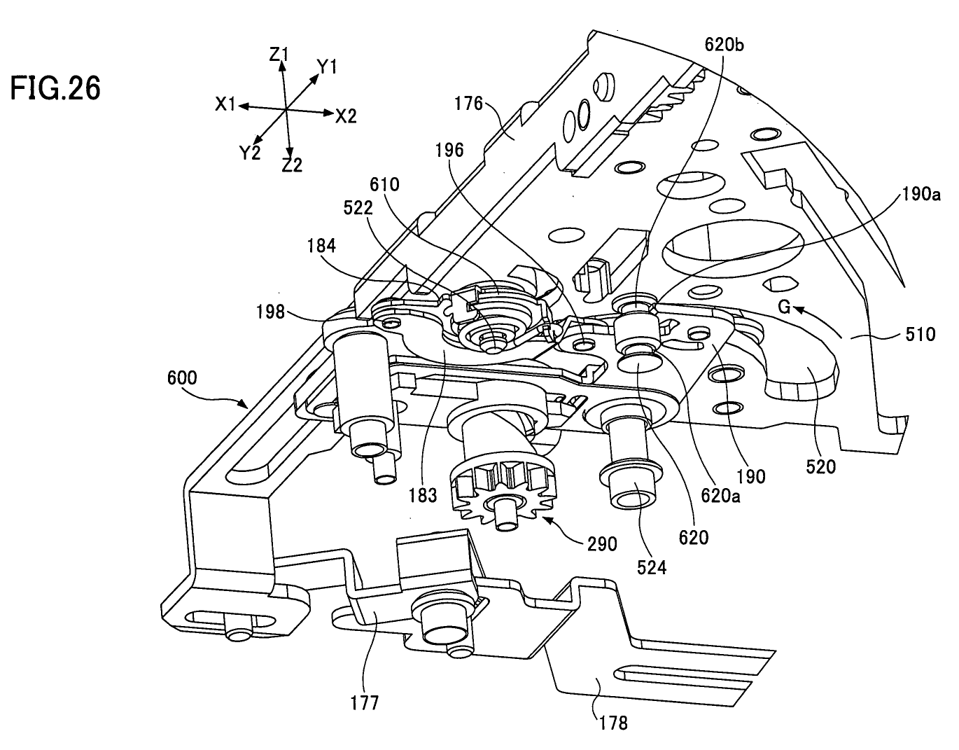

FIG. 26 is a perspective view of an underside of the tape guide moving mechanism 600 according to an embodiment of the present invention. As shown in FIG. 26, the lower surface of the sub-chassis 510 is provided with the supporting base 190, the first arm 183, the second arm 184, the spring receiving member 192, and the torsion spring 610 of the tape guide moving mechanism 600. Furthermore, the lower surface of the sub-chassis 510 has a positioning member 620 fixed thereto in an erect position in a downward direction), so that the tip of the supporting base 190 contacts the positioning member 620 when reaching the final tape loading position.

The supporting base 190 has the pole P9 standing upright on the upper surface of its distal end part and a sleeve provided on its proximal end part for allowing a stationary axle 524 of the sub-chassis 510 to be inserted therethrough. The supporting base 190 rotates around the stationary axle 524 in a clockwise direction (G direction) when a pulling force is applied in its rotating direction via the first arm 183 during the tape loading operation.

Furthermore, the supporting base 190 is coupled to the pole raising/lowering mechanism 290 which is configured to raise or lower a corresponding pole(s) according to the type (thickness) of the loaded tape cassette 10, 20 (described in detail below).

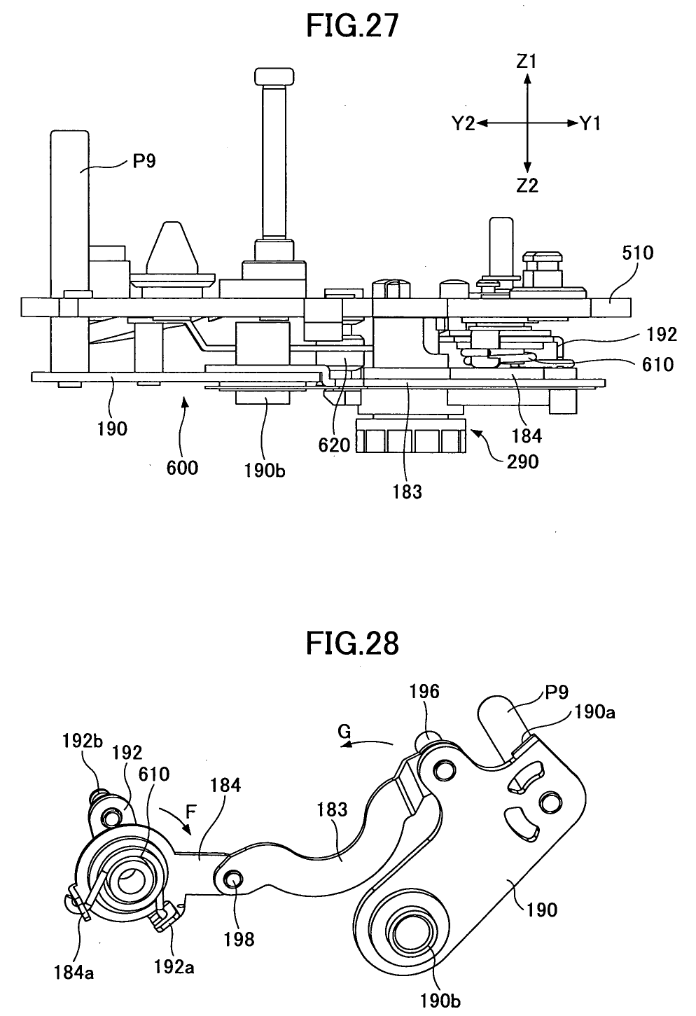

FIG. 27 is a side view of the tape guide moving mechanism 600 and the pole raising/lowering mechanism 290 according to an embodiment of the present invention. It is noted that FIG. 27 shows the position of the supporting base 190 in a state where the tape cassette 20 is loaded and lowered. The main chassis 50 is omitted in FIG. 27. As shown in FIG. 27, the torsion spring 610 is wound around the stationary axle 522 fixed to the lower surface of the sub-chassis 510 so that the spring receiving member 192 and the second arm 184 are rotatably supported. Thereby, the torsion spring 610 is compressed by the relative displacement between the spring receiving member 192 and the second arm 184. Accordingly, the torsion spring 610 generates a spring force corresponding to the amount of the compression. The spring force of the torsion spring 610 becomes a retaining force causing the supporting base 190 to press against the positioning member 620 and the pole P9 to maintain position at the tape path forming position.

Furthermore, the positioning member 620 has first and second trenches 620a, 620b provided to its outer periphery for engaging an engaging part 190a (shown in FIG. 28) provided at a distal end portion of the supporting base 190. The first and second trenches 620a, 620b each act as a stopper for determining the rotary position of the supporting base 190 after the tape loading operation and the position (height position) of the supporting base 190 after being raised/lowered according to the type (thickness) of the tape cassette 10, 20.

The first trench 620a provided at a lower part of the positioning member 620 is positioned at a predetermined height corresponding to a case where the tape cassette 10 is loaded. The second trench 620b provided at an upper part of the positioning member 620 is positioned at a predetermined height corresponding to a case where the tape cassette 20 is loaded.

Accordingly, by having the supporting base 190 engaged to the first trench 620a or the second trench 620b, the position of the supporting base 190 after the tape loading operation (final tape loading position) is determined (defined) with respect to the rotary position (horizontal direction) and the height position (vertical direction).

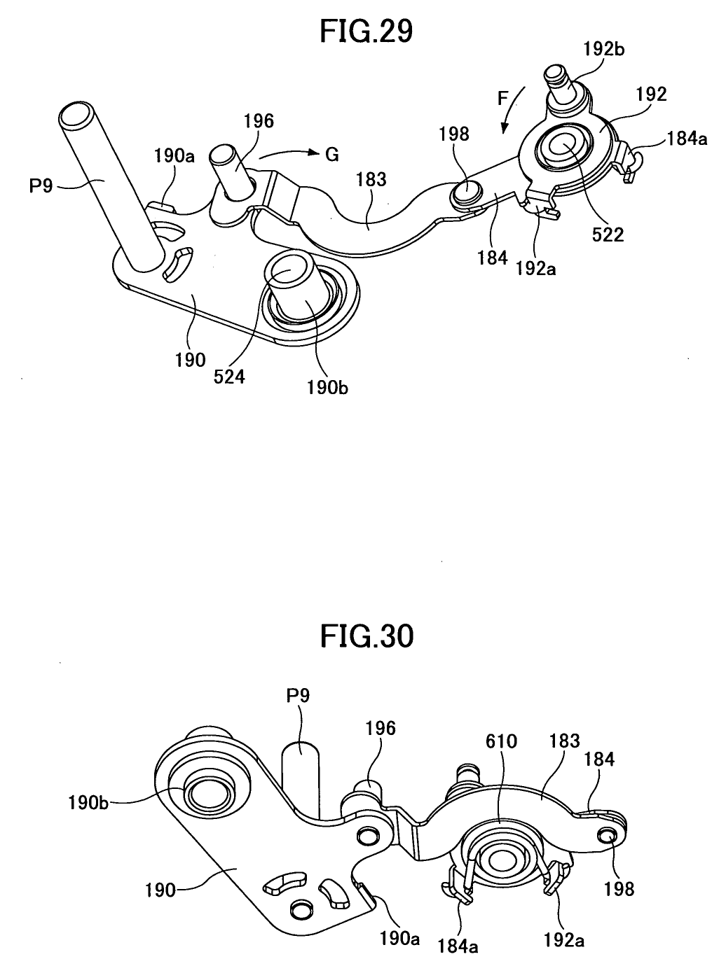

FIG. 28 is a perspective view of an underside of the tape guide moving mechanism 600 according to an embodiment of the present invention. FIG. 29 is an perspective view of a top side of the tape guide moving mechanism 600 according to an embodiment of the present invention. As shown in FIGS. 28 and 29, the supporting base 190 is connected to the first arm 183 configured as a link mechanism for pulling the magnetic tape 14/24 to the tape path forming position during the tape loading operation. The first arm 183 has one end (distal end) rotatably connected to the supporting base 190 via a first connecting pin 196. Furthermore, the other end (proximal end) of the first arm 183 is rotatably connected to one end (distal end) of the second arm 184 via a second connecting pin 198. Because the first arm 183 is pulled by having the second connecting pin 198 rotated to the opposite side of the first arm 183 (moved approximately 180 degrees), the middle portion of the first arm 183 is bent in an arc-shape for avoiding interference with, for example, the spring receiving member 192 or the stationary axle 522.

Furthermore, the other end (proximal end) of the second arm 184 is rotatably supported to the stationary axle 522 fixed to the lower surface of the chassis 510. The spring receiving member 192 is concentrically supported to the stationary axle 522 at the upper surface of the second arm 184. The torsion spring 610 wound around the stationary axle 522 has one end latched to a spring latching portion 192a of the spring receiving member 192 and another end latched to a spring latching portion 184a of the second arm 184.

A drive receiving pin 192b, to which a driving force is transmitted, is fixed to the upper surface of the spring receiving member 192.

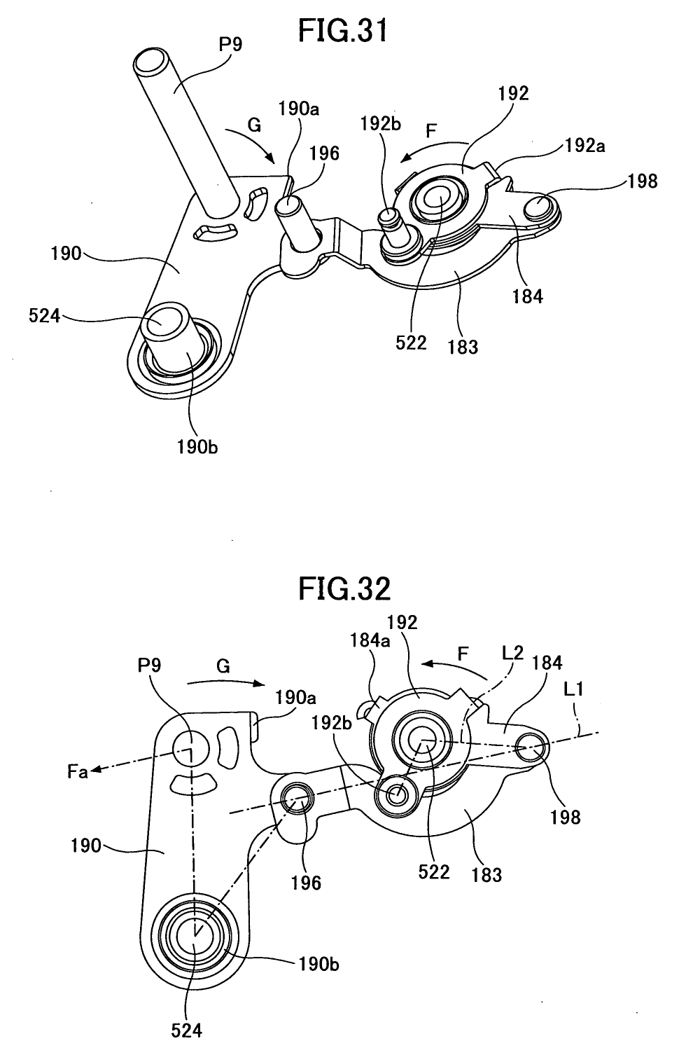

FIG. 30 is a perspective view of an underside of the tape guide moving mechanism 600 when the pole P9 is moved to a tape path forming position according to an embodiment of the present invention. FIG. 31 is a perspective view of a top side of the tape guide moving mechanism 600 when the pole P9 is moved to a tape path forming position according to an embodiment of the present invention. FIG. 32 is a top plan view of the tape guide moving mechanism 600 when the pole P9 is moved to a tape path forming position according to an embodiment of the present invention. As shown in FIGS. 30 through 32, when the drive receiving pin 192b is pressed in a counter-clockwise direction (F direction) via the oscillating member 194, the spring receiving member 192 and the second arm 184 connected via the torsion spring 610 are rotated in a counter-clockwise direction (F direction) around the stationary axle 522.

Thereby, the second connecting pin 198 that connects the first and second arms 183, 184 is also rotated in a counter-clockwise direction (F direction). Thus, the first arm 183 oscillates in a manner wrapping around the stationary axle 522 while rotating the first connecting pin 196 in a clockwise direction (G direction). The supporting base 190 stops at the tape path forming position when the engaging portion 190a engages the first trench 620a or the second trench 620b of the positioning member 620 fixed to the bottom surface of the sub-chassis 510.

Accordingly, when the drive receiving pin 192b of the spring receiving member 192 is driven in a counter-clockwise direction (F direction) in a state where the supporting base 190 is engaged to the positioning member 620, both ends of the torsion spring 610 latched to the spring receiving member 192 and the second arm 184 are displaced in a compressing direction by the relative displacement between the spring receiving member 192 and the second arm 184. As a result, a pressing force in a counter-clockwise direction (F direction) is applied to the second connecting pin 198, and a pressing force in a clockwise direction (G direction) is applied to the first connecting pin 196. The spring force generated by the elastic deformation of the torsion spring 610 acts as a binding force (pressing force) for engaging the engaging portion 190a of the supporting base 190 with the first trench 620a or the second trench 620b of the positioning member 620. Accordingly, the binding force of the torsion spring 610 allows the supporting base 190 to maintain position, to thereby determine the position of the supporting base 190 with respect to the rotary direction (horizontal direction) of the final tape loading position of the tape path 17-1 formed by the pole P9 and with respect to height (vertical direction).

As shown in FIG. 32, when the supporting base 190 is pulled to the tape path forming position by rotating the first and second arms 183, 184 in correspondence with the tape loading operation, the second connecting pin 198 is positioned at the opposite side of the first connecting pin 196 where the stationary axle 522 (serving as the center of rotation of the first arm 183) is interposed therebetween. Therefore, the tension (tape tension) Fa of the magnetic tape 14/24, which slidingly contacts the pole P9, is directed in a substantially same direction as the straight line L1 connecting the first connecting pin 196 and the second connecting pin 198.

Therefore, even in a case where there is a change in the tape tension Fa applied to the pole P9, the change hardly causes any undesired force for rotating the first arm 183 and the second arm 184 because the force of the tape tension Fa working to direct the supporting base 190 to a recovering direction is oriented substantially in the same direction as the straight line L1 connecting the first connecting pin 196 and the second connecting pin 198. Thereby, the pole P9 can securely maintain position without encountering any backlash (instability) due to changes of the tape tension Fa.

In addition, by positioning the stationary axle 522 between the first connecting pin 196 and the second connecting pin 198 in the vicinity of the straight line L1 (reducing the angle between the straight line L1 and the straight line L2 connecting the second connecting pin 198 and the stationary axle 522), the spring receiving member 192 rotating around the stationary axle 522 is hardly affected by a rotating force caused by an increase of the tape tension Fa. Accordingly, the tape path of the magnetic tape 14/24 slidingly contacting the pole P9 can be stably maintained.

The backlash at the connecting portions of the first arm 183, the second arm 184, the supporting base 190, and the spring member 192 is absorbed in the tape loading direction by the spring force of the torsion spring 610. Therefore, backlash of the pole P9 due to changes in the tape tension Fa can be reduced. For example, according to this embodiment, a force of 100 gf can be sufficiently attained at the pole P9 by setting the torque around the stationary axle 522 to 24 gf·cm through 25 gf·cm. Therefore, the pole P9 can be reinforced with a sufficient position maintaining strength even in a case where the torsion spring 610 has a weak spring force.

Accordingly, the pole P9 can stably maintain position even in a case where there is a change in the tape tension of the magnetic tape 14/24 that slidingly contacts the pole P9. Thus, the magnetic tape 14, 24 can be stably scanned by the rotating drum unit 31. As a result, magnetic recording and magnetic reproduction performance can be improved.

Furthermore, in the tape guide moving mechanism 600, because the stationary axle 522 is situated in the vicinity of the straight line L1 after the tape loading operation, the position maintaining force of the pole P9 can be attained even in a case where the spring force of the torsion spring 610 is reduced. Therefore, when raising the supporting base 190, the resistance generated by the sliding movement between the first connecting pin 196 and the first arm 183 can be reduced, so that the tape loading operation can be performed smoothly. Furthermore, because the compressing operation by the torsion spring 610 is conducted at the final stage of the loading operation, the workload during the loading operation can be reduced. Thereby, the tape loading operation can be performed with a small amount of driving force.

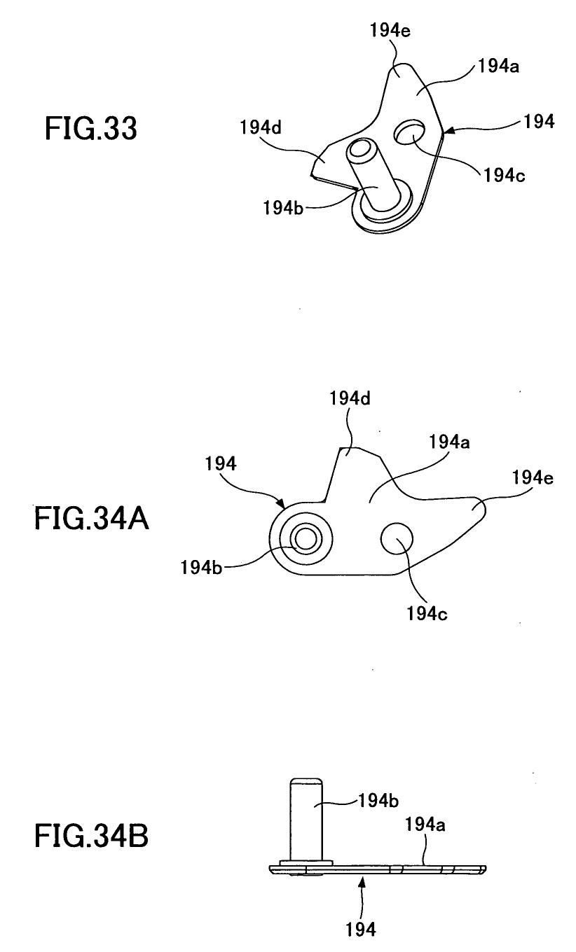

In the following, the oscillating member 194 is described. FIG. 33 is a perspective view of a top side of the oscillating member 194 according to an embodiment of the present invention. FIG. 34A is a plan view of the oscillating member 194 according to an embodiment of the present invention. FIG. 34B is a side view of the oscillating member 194 according to an embodiment of the present invention. As shown in FIGS. 33 through 34B, the oscillating member 194 includes: a base 194a to be placed on the upper surface of the sub-chassis 510; an engaging pin 194b positioned upright on the upper surface of the base 194a; and a hole 194c provided in the base 194a through which the drive receiving pin 192b is inserted. Furthermore, the base 194a includes first and second cams 194d, 194e protruding in a manner forming a V-shape.

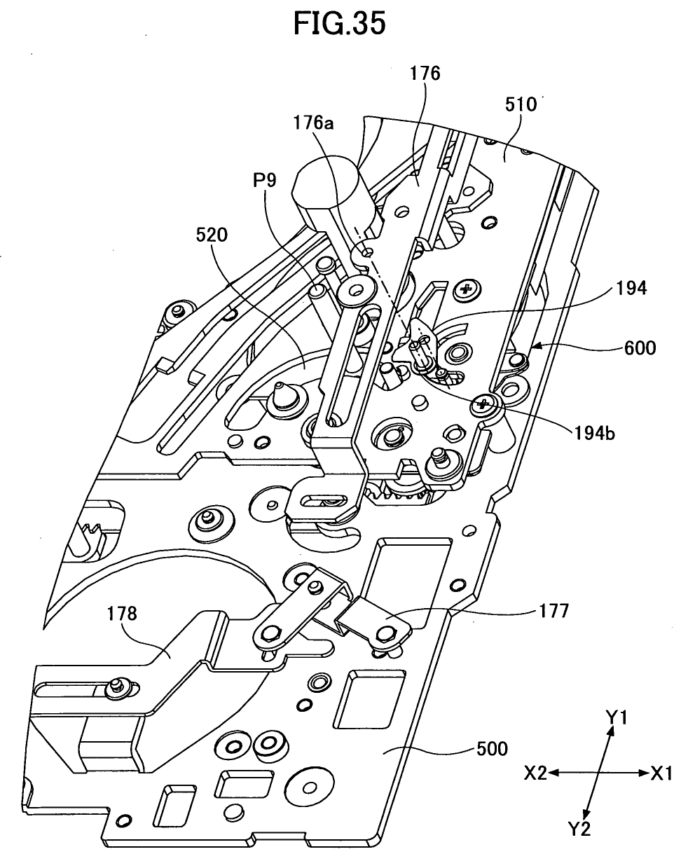

FIG. 35 is a perspective view showing an attached state of the oscillating member 194 according to an embodiment of the present invention.

In FIG. 35, the slide lever 176 is raised for making the attached state of the oscillating member 194 more visible. As shown in FIG. 35, the oscillating member 194 has the engaging pin 194b inserted through a hole 176a of the slide lever 176, and the drive receiving pin 192b of the spring receiving member 192 inserted through the hole 194c. Accordingly, the relative displacement between the engaging pin 194b and the drive receiving pin 192b causes the oscillating member 194 to oscillate when the slide lever 176 slides in the Y2 direction.

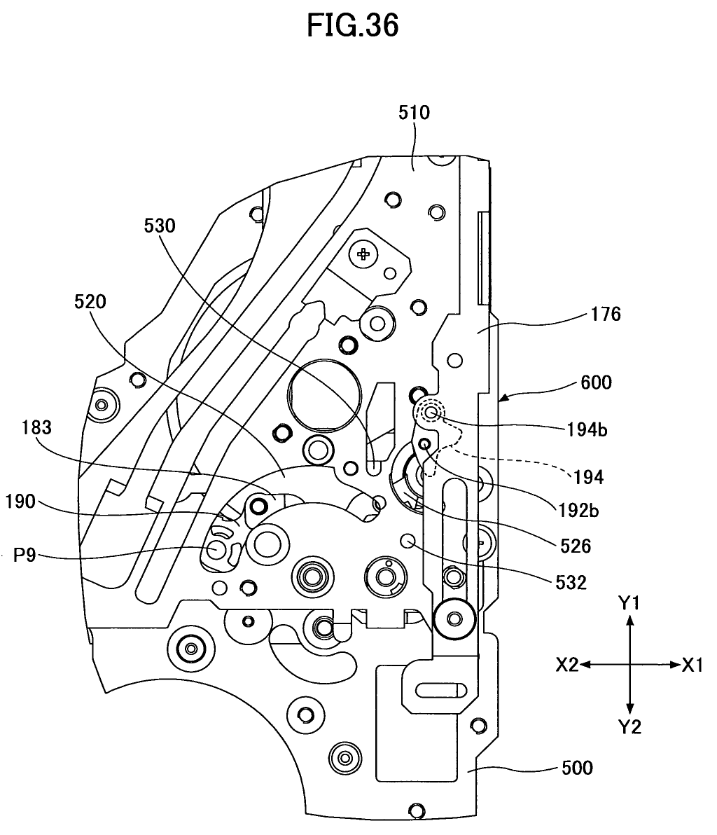

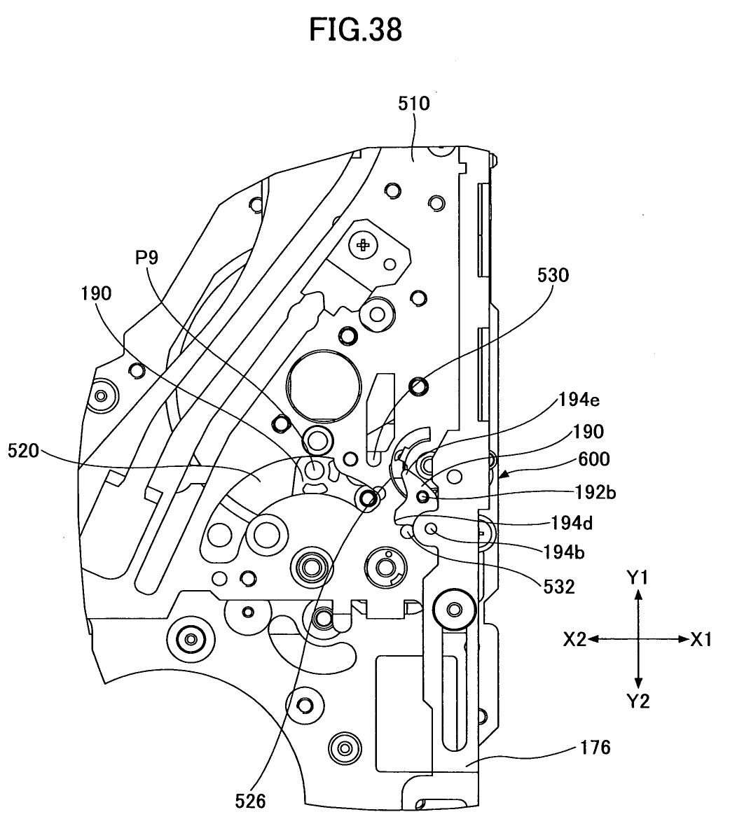

In the following, operations of the oscillating member 194 are described with reference to FIGS. 36 through 38. In the oscillating member 194 shown in FIG. 36, the engaging pin 194b is situated in the Y1 direction and the drive receiving pin 192b is situated in the Y2 direction. Therefore, the first and second cams 194d, 194e are hidden below the slide lever 176. In the state before the tape loading operation, the drive receiving pin 192b, which is inserted through the arc-shaped opening 526 of the sub-chassis 510, is positioned towards the clockwise side of the arc-shaped opening 526.

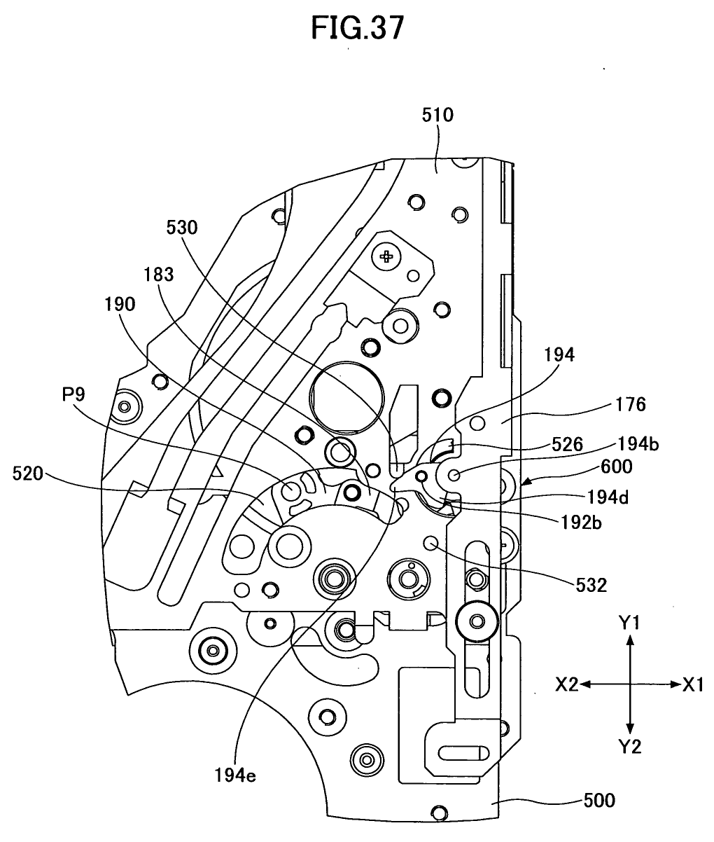

As shown in FIG. 37, when the slide lever 176 slides in the Y2 direction and the tape loading operation is initiated, the engaging pin 194b moves in the Y2 direction and the drive receiving pin 192b rotates in a counter-clockwise direction in the arc-shaped opening 526. Then, the engaging pin 194b and the drive receiving pin 192b become aligned substantially at the same position where the engaging pin 194b is situated toward the X1 direction and the drive receiving pin 192b is situated toward the X2 direction. Thereby, the second cam 194e rotating in a clockwise direction and moving in a direction away from the slide lever 176 contacts a protrusion 530 fixed to the upper surface of the sub-chassis 510.

Thus, because the rotation of the oscillating member 194 in the clockwise direction is limited by contacting the protrusion 530, the drive receiving pin 192b can be driven in a counter-clockwise direction (F direction) as the slide lever 176 slides in the Y2 direction.

Then, as the tape loading operation continues and the slide lever 176 further slides in the Y2 direction, the engaging pin 194b moves in the Y2 direction and the oscillating member 194 moves in the clockwise direction, so that the first cam 194d contacts a protrusion 532 fixed to the upper surface of the sub-chassis 510.

Thus, because the rotation of the oscillating member 194 in the clockwise direction is limited by contacting the protrusion 532, the drive receiving pin 192b can be driven in a counter-clockwise direction (F direction) as the slide lever 176 slides in the Y2 direction.

Accordingly, the oscillating member 194 converts the sliding movement of the slide lever 176 to a rotating movement and transmits a driving force to the spring receiving member 192 in the counter-clockwise direction (F direction). Thus, even in a case where the area (range) of the movement of the drive receiving pin 192b is separated from the area (range) of the movement of the slide lever 176, the driving force can be transmitted from the slide lever 176 to the drive receiving pin 192b via the oscillating member 194, and the pole P9 can be moved to the tape path forming position.

Thereby, with the oscillating member 194 provided with a size corresponding to the separated distance between the drive receiving pin 192b and the slide lever 176, the relationship in the position between the slide lever 176 and the spring receiving member 192 can be arbitrarily determined. This increases the amount of freedom in designing the magnetic recording/reproducing apparatus 30.

In the following, an embodiment of the pole raising/lowering mechanism 290 for raising/lowering the pole P9 according to the type of the tape cassette 10, 20 is described.

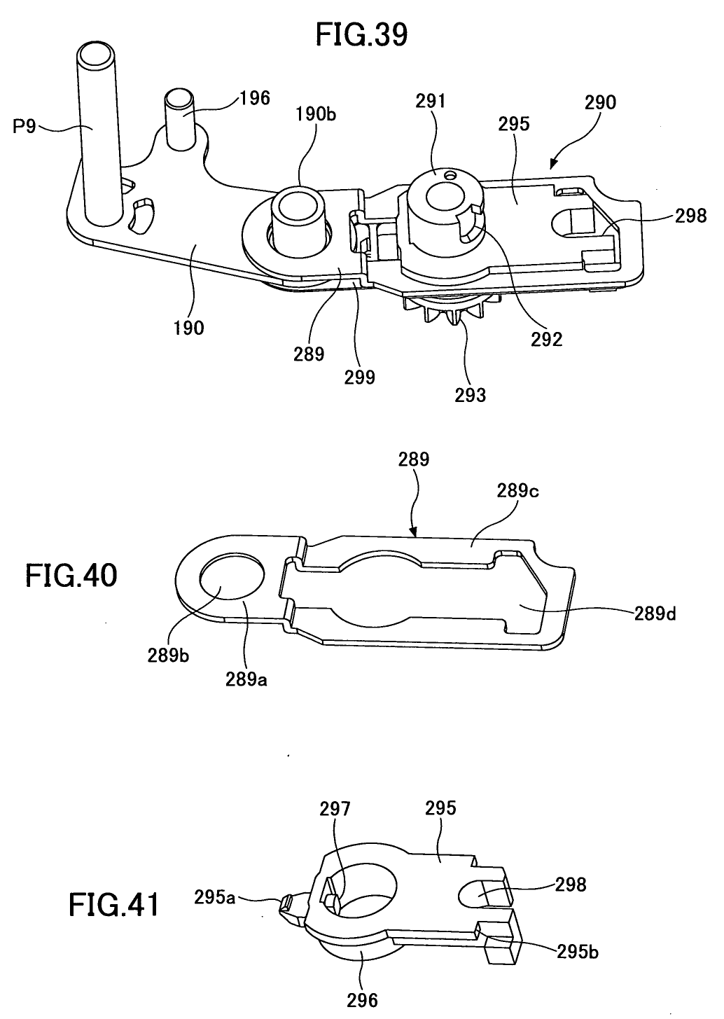

FIG. 39 is a perspective view showing the pole raising/lowering mechanism 290. As shown in FIG. 39, the pole raising/lowering mechanism 290 includes a spiral cam member 291 and a raising/lowering member 295. As shown in FIG. 22, the spiral cam member 291 is engaged and supported by a stationary post that is fixed to the chassis base, and includes a gear 293 that is engaged with the rack 306.

The raising/lowering member 295 has an upper plate 289 fixed to its upper surface and a lower plate 299 fixed to its lower surface. The upper plate 289 and the lower plate 299 are attached in a manner that the supporting base 190 is sandwiched in a vertical direction at the tip parts of the upper plate 289 and the lower plate 299. FIG. 40 is a perspective view showing the upper plate 289 according to an embodiment of the present invention. As shown in FIG. 40, the upper plate 289 has one end portion 289a provided with a circular hole 289b for engaging with a sleeve 190b of the supporting base 190. The other end portion 289c of the upper plate 289 is provided with a non-circular opening 289d for engaging with the raising/lowering member 295.

FIG. 41 is a perspective view showing the raising/lowering member 295. As shown in FIG. 41, the raising/lowering member 295 includes a cylindrical portion 296 for engaging the spiral cam member 291. The cylindrical portion 296 includes a cam follower 297 for engaging a spiral cam trench 292. Furthermore, on one end of the raising/lowering member 295, a latching portion 295a is provided. On the other end of the raising/lowering member 295, there is a U-shaped trench portion 298 which is to engaged and fit a stationary post 308 fixed to the chassis base (See FIG. 22). Furthermore, the raising/lowering member 295 also includes a protruding portion 295b provided on the outer side of the cylindrical portion 296.

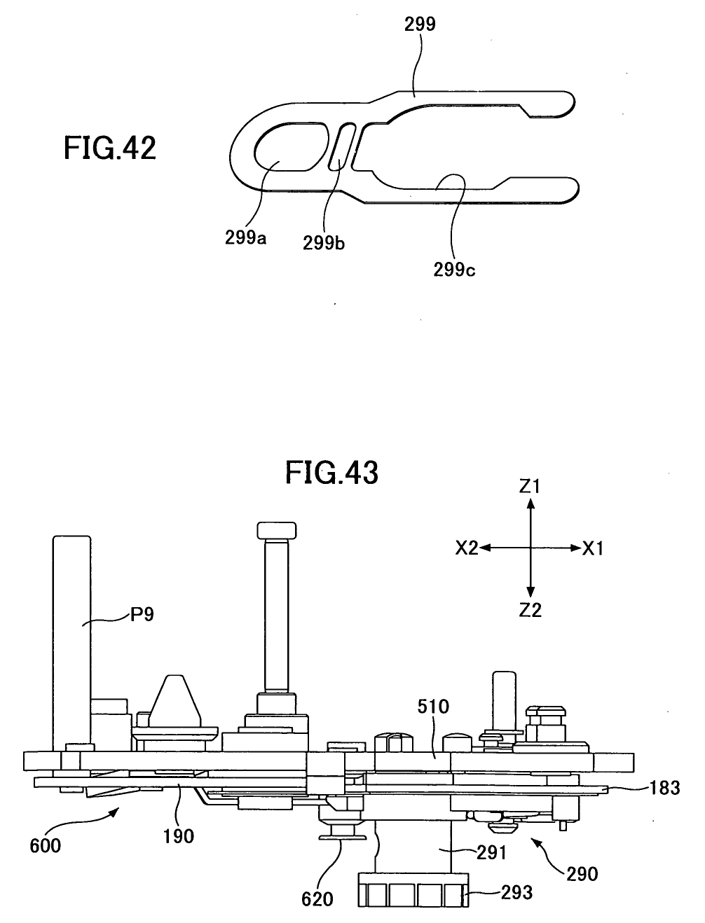

FIG. 42 is a perspective view showing the lower plate 299 according to an embodiment of the present invention. As shown in FIG. 42, the lower plate 299 includes a circular hole 299a for engaging the sleeve 190b of the supporting base 190, a latching hole 299a for latching the latching portion 295a, and an opening 299c for inserting the cylindrical portion 296 therethrough. The raising/lowering member 295 is coupled to the upper plate 289 and the lower plate 299 by having the latching portion 295a latched to the latching hole 299b of the lower plate 299 and the protruding portion 295b contacting the upper surface of the upper plate 289.

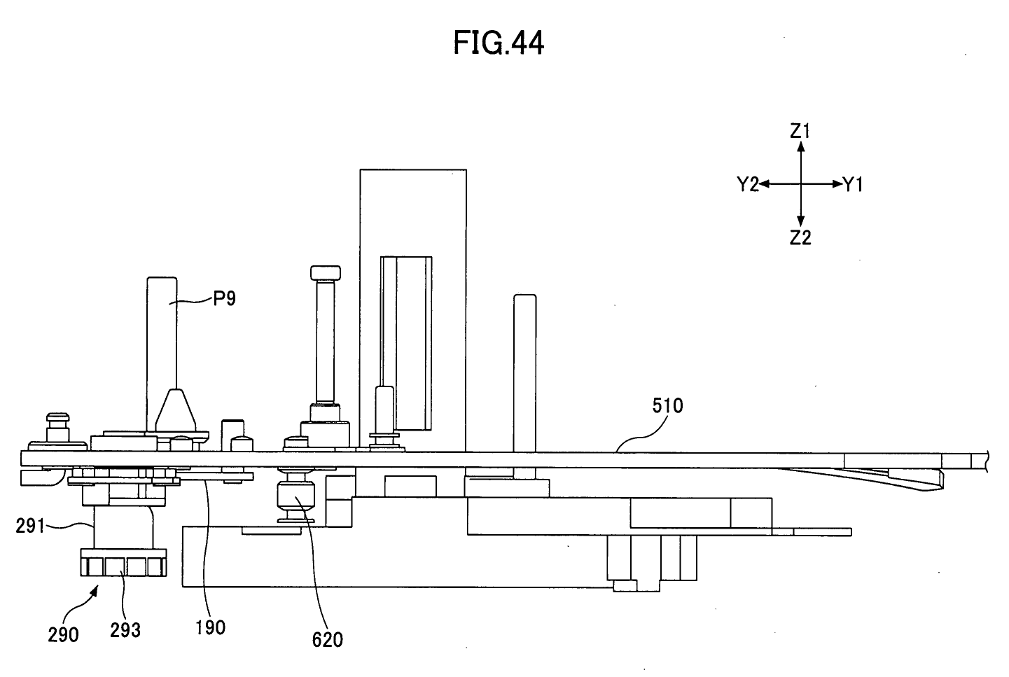

As shown in FIG. 22, when the slide lever 302 is made to slide in the X1 direction, the gear 293 is rotated in a counter-clockwise direction by the rack 306. Thereby, the spiral cam member 291 is rotated in a counter-clockwise direction; the cam follower 297 is guided by the spiral cam trench 292; and the raising/lowering member 295, the upper plate 289, and the lower plate 299 are moved in the Z1 direction. Then, as shown in FIGS. 43 and 44, the supporting base 190 is raised by the lower plate 299 coupled to the raising/lowering member 295, to thereby raise the pole P9.

It is noted that the tape unloading operations are performed by the above-described operations in reverse order. A detailed description of the tape unloading operations is omitted.

The above-described embodiments of the present invention show an exemplary configuration where the torsion spring 610 is positioned in a manner allowing it to be compressed by the relative displacement between the spring receiving member 192 and the second arm 184. However, a spring member may alternatively be positioned at other areas. Furthermore, a spring member other than a torsion spring (e.g., coil spring) may be used for transmitting a spring force to the second arm 184. In such a case, the spring receiving member 192 and the second arm 184 may be integrally formed as a united body.

Further, it is noted that the present invention is not limited to the specific embodiments described above, and variations and modifications may be made without departing from the scope of the present invention. For example, the present invention may be applied to a recording/reproducing device using a magnetic tape other than a streamer device.

The present application is based on Japanese Priority Application No. 2007-126809 filed on May 11, 2007, with the Japanese Patent Office, the entire contents of which are hereby incorporated by reference.

What is claimed is:

1. A magnetic recording/reproducing apparatus including a rotating drum unit for recording data to a magnetic tape of a tape cassette or reproducing data recorded to the magnetic tape, a tape guiding member for pulling the magnetic tape out from the tape cassette for forming a tape path, a tape loading member for winding the magnetic tape around the rotating drum unit, comprising:
a tape guide moving mechanism including
a driving force transmitting member configured to transmit a driving force,
a supporting base configured to support the tape guiding member,
a first arm member having one end rotatably connected to the supporting base via a first connecting pin, and
a second arm member configured to connect the first arm part and the driving force transmitting part and configured to rotatably connect to the other end of the first arm member via a second connecting pin.

2. The magnetic recording/reproducing apparatus as claimed in claim 1, wherein the second connecting pin is positioned on an opposite side of the first connecting pin when the supporting base is moved to a position for forming the tape path by rotating the first and second arm members along with sliding the driving force transmitting member.

3. The magnetic recording/reproducing apparatus as claimed in claim 1, further comprising an oscillating member, wherein the second arm member is configured to convert the sliding movement of the driving force transmitting mechanism via the oscillating member.

4. The magnetic recording/reproducing apparatus as claimed in claim 1, further comprising:
a positioning member which the supporting base contacts when the supporting base is moved to the position for forming the tape path by the rotation of the first and second arm members, and
a pressing member for pressing the supporting base against the positioning member in correspondence with the sliding movement of the driving force transmitting mechanism after the supporting base contacts the positioning member.

5. The magnetic recording/reproducing apparatus as claimed in claim 1, wherein the positioning member is configured to determine the position of the supporting base with respect to the horizontal direction and the vertical direction.
